(19) United States
(12) Patent Application Publication
(10) Pub. No.: US 2024/0205695 A1
(43) Pub. Date: Jun. 20, 2024

(54) COMMON SPATIAL FILTER UPDATES FOR MULTI-DOWNLINK CONTROL INFORMATION (DCI) BASED MULTI-TRANSMISSION RECEPTION POINT (TRP) SYSTEMS

(71) Applicant: Telefonaktiebolaget LM Ericsson (publ), Stockholm (SE)

(72) Inventors: Siva MURUGANATHAN, Stittsville (CA); Andreas NILSSON, Göteborg (SE); Shiwei GAO, Nepean (CA)

(21) Appl. No.: 18/554,850

(22) PCT Filed: Apr. 13, 2022
(86) PCT No.: PCT/IB2022/053494

§ 371 Date: Oct. 11, 2023

Related U.S. Application Data
(60) Provisional application No. 63/174,273, filed on Apr. 13, 2021.

(51) Int. Cl. H04W 16/28; H04B 7/06; H04W 72/232; H04W 76/20

(52) U.S. Cl. CPC H04W 16/28; H04B 7/06968; H04W 72/232; H04W 76/20

(57) ABSTRACT

A method, system, and apparatus are disclosed for common spatial filter updates for multi-DCI based multi-TRP systems. A method implemented by a network node is provided. At least one downlink resource for transmission is determined, where the at least one downlink resource belongs to a first CORESET of a plurality of CORESETs, which is associated with a respective CORESET pool index. The at least one first downlink signal is transmitted to the wireless device on the determined at least one downlink resource. At least one second downlink signal is transmitted where the at least one second downlink signal is received by the wireless device based on a QCL parameter, associated with the CORESET pool index. At least one uplink signal is transmitted by the wireless device based on a first spatial domain filter which is associated with the CORESET pool index.

### FIELD

The present disclosure relates to wireless communications, and in particular, to common spatial filter updates for multiple-downlink control information (multi-DCI) based multiple-transmit receive points (multi-TRP) systems.

### BACKGROUND

In 3^{rd} Generation Partnership Project (3GPP) New Radio (NR, also called 5th Generation or 5G) several signals can be transmitted from different antenna ports of a same network node (e.g., base station). These signals can have the same large-scale properties such as Doppler shift/spread, average delay spread, or average delay. These antenna ports are then said to be quasi co-located (QCL).

If the wireless device (WD, also called user equipment or UE) knows that two antenna ports are QCL with respect to a certain parameter (e.g., Doppler spread), the wireless device can estimate that parameter based on one of the antenna ports and apply that estimate for receiving signal on the other antenna port.

For example, there may be a QCL relation between a channel state information reference signal (CSI-RS) for a tracking RS (TRS) and the physical downlink shared channel (PDSCH) demodulation reference signal (DMRS). When wireless device receives the PDSCH DMRS it can use the measurements already made on the TRS to assist the DMRS reception.

Information about what assumptions can be made regarding QCL is signaled to the wireless device from the network. In NR, four types of QCL relations between a transmitted source RS and transmitted target RS may be defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the wireless device can use the same Rx beam to receive them. This is helpful for a wireless device that uses analog beamforming to receive signals, since the wireless device needs to adjust its RX beam in some direction prior to receiving a certain signal. If the wireless device knows that the signal is spatially QCL with some other signal it has received earlier, then it can safely use the same RX beam to receive also this signal. Note that for beam management, the discussion mostly revolves around QCL Type D, but it may also be useful to convey a Type A QCL relation for the RSs to the wireless device, so that the wireless device can estimate all the relevant large-scale parameters.

Typically, this is achieved by configuring the wireless device with a CSI-RS for tracking (TRS) for time/frequency offset estimation. To be able to use any QCL reference, the wireless device would have to receive it with a sufficiently good signal-to-interference-plus-noise ratio (SINR). In many cases, this means that the TRS must/may be transmitted in a suitable beam to a certain wireless device.

To introduce dynamics in beam and transmission point (TRP) selection, the wireless device can be configured through radio resource control (RRC) signaling with up to 128 TCI (Transmission Configuration Indicator) states. The TCI state information element is shown below:

| | |
|---|---|
| TCI-State ::= | SEQUENCE { |
| tci-StateId | Tri-State, |
| qcl-Type1 | QCL-Info, |
| qcl-Type2 | QCL-Info |
| . . . | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |

. . .
}

Each TCI state contains QCL information related to one or two RSs. For example, a TCI state may contain CSI-RS1 associated with QCL Type A and CSI-RS2 associated with QCL Type D. If a third RS, e.g., the PDCCH DMRS, has this TCI state as QCL source, it means that the wireless device can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via medium access control (MAC) control element (CE) one TCI state for PDCCH (i.e., provides a TCI for PDCCH) and up to eight TCI states for PDSCH. The number of active TCI states the wireless device support is a wireless device capability, but the maximum is 8.

Assume a wireless device has 4 activated TCI states (from a list of totally 64 configured TCI states). Hence, 60 TCI states are inactive for this particular wireless device and the wireless device needs not be prepared to have large scale parameters estimated for those inactive TCI states. But the wireless device continuously tracks and updates the large scale parameters for the RSs in the 4 active TCI states. When scheduling a PDSCH to a wireless device, the DCI contains a pointer to one activated TCI state. The wireless device then knows which large scale parameter estimate to use when performing PDSCH DMRS channel estimation and thus PDSCH demodulation.

As long as the wireless device can use any of the currently activated TCI states, it is sufficient to use DCI signaling. However, at some point in time, none of the source RSs in the currently activated TCI states can be received by the wireless device, i.e., when the wireless device moves out of the beams in which the source RSs in the activated TCI states are transmitted. When this happens (or actually before this happens), the network node (e.g., gNB) would have to activate new TCI states. Typically, since the number of activated TCI states is fixed, the network node (e.g., gNB) would also have to deactivate one or more of the currently activated TCI states.

A two-step procedure related to TCI state update is depicted in FIG. 1.

### TCI States Activation/Deactivation for Wireless Device-Specific PDSCH Via MAC CE

Now details of the MAC CE signaling that are used to activate/deactivate TCI states for wireless device specific PDSCH is described. The structure of the MAC CE for activating/deactivating TCI states for wireless device specific PDSCH is given in FIG. 2.

As shown in FIG. 2, the MAC CE contains the following fields:
Serving Cell identifier (ID): This field indicates the identity of the Serving Cell for which the MAC CE applies. The length of the field is 5 bits;
·Bandwidth part (BWP) ID: This field contains the ID corresponding to a downlink bandwidth part for which the MAC CE applies. The BWP ID is given by the higher layer parameter BWP-Id as specified in, for example, 3GPP Technical Specification (TS) 38.331. The length of the BWP ID field is 2 bits since a wireless device can be configured with up to 4 BWPs for downlink (DL);
A variable number of fields Tᵢ: If the wireless device is configured with a TCI state with TCI State ID i, then the field Tᵢ indicates the activation/deactivation status of the TCI state with TCI State ID i. If the wireless device is not configured with a TCI state with TCI State ID i, the MAC entity shall/may ignore the Tᵢ field. The Tᵢ field is set to “1” to indicate that the TCI state with TCI State ID i is to be activated and mapped to a codepoint of the DCI Transmission Configuration Indication (TCI) field, as specified in 3GPP TS 38.214/38.321. The Tᵢ field is set to “0” to indicate that the TCI state with TCI State ID i is to be deactivated and is not mapped to any codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” is to be mapped to the codepoint value 0 of DCI Transmission Configuration Indication field, the second TCI State with Tᵢ field set to “1” is to be mapped to the codepoint value 1 of DCI Transmission Configuration Indication field, and so on. In NR Release 15 (Rel-15), the maximum number of activated TCI states is 8;
A Reserved bit R: this bit is set to ‘0’ in NR Rel-15.

Note that the TCI States Activation/Deactivation for wireless device-specific PDSCH MAC CE is identified by a MAC PDU subheader with logical channel ID (LCID), for example as specified in Table 6.2.1-1 of 3GPP TS 38.321 (this table is reproduced FIG. 2). The MAC CE for Activation/Deactivation of TCI States for wireless device-specific PDSCH has variable size.

### TCI State Indication for Wireless Device-Specific PDSCH Via DCI

The network node (e.g., gNB) can use DCI format 1_1 or 1_2 to indicate to the wireless device to use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 3.

### Multi-TRP TCI State Operation

In 3GPP Release 16 (Rel-16), a multi-TRP (multiple-transmission reception point) operation was specified and it has two modes of operation, single DCI based multi-TRP and multiple DCI based multi-TRP.

In NR Rel-16, multiple DCI scheduling is for multi-TRP in which a wireless device may receive two DCIs each scheduling a physical downlink shared channel/physical uplink shared channel (PDSCH/PUSCH). Each PDCCH and PDSCH are transmitted from the same TRP.

For multi-DCI multi-TRP operation, a wireless device is to be configured with two CORESET pools, each associated with a TRP. Each CORESET pool is a collection of CORESETs that belongs to the same CORESET pool. A CORESET pool index can be configured in each CORESET with a value of 0 or 1. For the two DCIs in the above example, they are transmitted in two CORESETs belonging to different CORESET pools (i.e., with CORESETPoolIndex 0 and 1, respectively). For each CORESET Pool, the same TCI state operation method in terms of activation/deactivation/indication as described above may be assumed.

The other multi-TRP mode, single DCI based mTRP, uses two DL TCI states to be associated to one DCI codepoint. That is, when a TCI field codepoint in DCI indicates two TCI states, each TCI state corresponding to a different beam or different TRP. The activation and mapping of 2 TCI states for a codepoint in the TCI field of DCI is done with the below MAC CE from 3GPP TS 38.321:

### Enhanced TCI States Activation/Deactivation for Wireless Device-Specific PDSCH MAC CE

The Enhanced TCI States Activation/Deactivation for wireless device-specific PDSCH MAC CE is identified by a MAC protocol data unit (PDU) subheader with eLCID as specified in Table 6.2.1-1b. It has a variable size and includes following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in 3GPP TS 38.212. The length of the BWP ID field is 2 bits;
Cᵢ: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j}: This field indicates the TCI state identified by TCI-StateId as specified in TS 38.331, where i is the index of the codepoint of the DCI Transmission configuration indication field as specified in TS 38.212 and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e., the first TCI codepoint with TCI state ID_{0,1} and TCI state ID_{0,2} shall/may be mapped to the codepoint value 0, the second TCI codepoint with TCI state ID_{1,1} and TCI state ID_{1,2} shall/may be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to “0”.

FIG. 4 illustrates an example of enhanced TCI States Activation/Deactivation for wireless device-specific PDSCH MAC CE.

### Inter-Cell Multi-TRP Operation

In NR 3GPP Release 17 (Rel-17), Inter-cell multi-TRP operation is to be specified. This is an extension of either single DCI based multi-TRP or multiple DCI based multi-TRP operation of Release 16. The intercell aspect of Rel-17 refers to the case when the two TRPs are associated to a different synchronization signal block (SSB) associated with different PCIs (Physical Cell IDs). That is, the TCI state that refers to transmission from TRP 1 or TRP 2 is quasi-collocated to a reference signal that is either one of the SSB beams with the PCI belonging to that TRP, or another reference signal like CSI-RS or DMRS that has root quasi-collocation assumption to one of the SSB beams with PCI belonging to that TRP.

### 3GPP Rel-17 TCI State Framework

In 3GPP Rel-17 a new unified TCI state framework is be specified, which aims to streamline the indication of transmit/receive spatial filter (and other QCL properties) to the wireless device by letting a single TCI state indicate QCL properties for multiple different DL and/or uplink (UL) signals/channels. Which DL/UL signals/channels that the unified TCI state framework should be applied to is still being debated in 3GPP, see some considerations that have been discussed below:

### Considerations:

For the 3GPP Rel-17 unified TCI framework:
Whether DL or, if applicable, joint TCI also applies to the following signals. If not, for further study (FFS) any other enhancement over Rel-15/16:
   CSI-RS resources for CSI;
   Some CSI-RS resources for BM, if so, which ones (e.g., aperiodic, repetition ‘ON’);
   CSI-RS for tracking;
Whether UL or, if applicable, joint TCI also applies to the following signals;
   Some SRS resources or resource sets for BM;

It was considered that the new unified TCI state framework may include a three stage TCI state indication (in a similar way as was described above for PDSCH) for all or a subset of all DL and/or UL channels/signals. In the first stage, RRC is used to configure a pool of TCI states. In the second stage, one or more of the RRC configured TCI states are activated via MAC-CE signaling and associated to different TCI field codepoints in DCI format 1_1 and 1_2. Finally, in the third stage, DCI signaling is used to select one of the TCI states (or two TCI states in case separate TCI states are used for DL channels/signals and UL channels/signals) that was activated via MAC-CE.

It was considered to support both joint beam indication (“Joint DL/UL TCI”) and separate DL/UL beam indication (“Separate DL/UL TCI”), as can be seen in the considerations below. For Joint DL/UL TCI, a single TCI state (which for example can be a DL TCI state or a Joint TCI state) is used to determine a transmit/receive spatial filter for both DL signals/channels and UL signals/channels. For Separate DL/UL TCI, one TCI state (for example a DL TCI state) can be used to indicate a receive spatial filter for DL signals/channels and a separate TCI state (for example an UL TCI state) can be used to indicate a transmit spatial filter for UL signals/channels.

### Considerations:

For beam indication signaling medium to support joint or separate DL/UL beam indication in Rel-17 unified TCI framework:
Support Layer 1 (L1)-based beam indication using at least wireless device-specific (unicast) DCI to indicate joint or separate DL/UL beam indication from the active TCI states
   The existing DCI formats 1_1 and 1_2 are reused for beam indication
Support activation of one or more TCI states via MAC CE analogous to Rel-15/16:

### Considerations:

For 3GPP Rel-17 unified TCI framework, to accommodate the case of separate beam indication for UL and DL:
Utilize two separate TCI states, one for DL and one for UL.
For the separate DL TCI:
   The source reference signal(s) in M TCIs provide QCL information at least for wireless device-dedicated reception on PDSCH and for wireless device-dedicated reception on all or subset of CORESETs in a CC.
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC.
   Optionally, this UL TX spatial filter can also apply to all sounding reference signal (SRS) resources in resource set(s) configured for antenna switching/codebook-based/non-codebook-based UL transmissions.
FFS: Whether the UL TCI state is taken from a common/same or separate TCI state pool from DL TCI state.

### SUMMARY

Some embodiments advantageously provide methods, systems, and apparatuses for common spatial filter updates for multi-DCI based multi-TRP systems.

In one embodiment, a network node is configured to one or more of: transmit information associating at least one first reference signal and/or at one first channel to at least a first subset of control resource sets (CORESETs);

transmit information associating at least one second reference signal and/or at least one second channel to at least a second subset of CORESETs;

transmit a downlink control information (DCI) on a physical downlink control channel (PDCCH) in a CORESET to the wireless device; and

transmit to and/or receive signaling from the wireless device, the signaling being transmitted/received based at least in part on quasi-colocation (QCL) information, the QCL information being based at least in part on which one of the first and second subset of CORESETs that the CORESET the DCI is transmitted on belongs to.

In another embodiment, a wireless device is configured to one or more of:

receive information associating at least one first reference signal and/or at one first channel to at least a first subset of control resource sets (CORESETs);

receive information associating at least one second reference signal and/or at least one second channel to at least a second subset of CORESETs;

receive a downlink control information (DCI) on a physical downlink control channel (PDCCH) in a CORESET to the wireless device; and

transmit and/or receive signaling, the signaling being transmitted/received based at least in part on quasi-colocation (QCL) information, the QCL information being based at least in part on which one of the first and second subset of CORESETs that the CORESET the DCI is received on belongs to.

According to one aspect of the present disclosure, a network node configured to communicate with a wireless device is provided. The network node includes processing circuitry configured to: determine at least one downlink resource for transmission to the wireless device, where the at least one downlink resource belongs to a first control resource set, CORESET, of a plurality of CORESETs, and the first CORESET is associated with a respective CORESET pool index. The processing circuitry is further configured to cause transmission of at least one first downlink signal to the wireless device on the determined at least one downlink resource. The processing circuitry is further configured to at least one of: cause transmission of at least one second downlink signal to the wireless device, where the at least one second downlink signal is received by the wireless device based on a quasi-colocation, QCL, parameter, and the QCL parameter is associated with the CORESET pool index; and receive at least one uplink signal transmitted by the wireless device, where the at least one uplink signal is transmitted by the wireless device based on a first spatial domain filter, and the first spatial domain filter is associated with the CORESET pool index.

According to one or more embodiments of this aspect, the at least one second downlink signal is a physical downlink shared channel, PDSCH, and the causing transmission of the at least one second downlink signal is triggered by the first downlink signal. According to one or more embodiments of this aspect, the at least one first downlink signal is configured to cause the wireless device to transmit the at least one uplink signal. According to one or more embodiments of this aspect, the at least one first downlink signal includes a downlink control information, DCI, message, and the DCI message includes a transmission configuration indicator, TCI, field that includes a TCI value indicating at least one indicated TCI state.

According to one or more embodiments of this aspect, the QCL parameter is further based on the at least one indicated TCI state. According to one or more embodiments of this aspect, the first spatial domain filter is further based on the at least one indicated TCI state. According to one or more embodiments of this aspect, wherein the TCI value includes at least one TCI field codepoint, the at least one TCI field codepoint being associated with the at least one indicated TCI state. According to one or more embodiments of this aspect, the at least one TCI field codepoint is mapped to the at least one indicated TCI state based on a format of the at least one first downlink signal.

According to one or more embodiments of this aspect, each of the at least one indicated TCI state indicates at least one of a joint TCI state, a downlink TCI state, and an uplink TCI state. According to one or more embodiments of this aspect, the at least one second downlink signal is received by the wireless device based on a downlink beam, the downlink beam is determined based on a second spatial domain filter, and the second spatial domain filter is associated with the CORESET pool index. According to one or more embodiments of this aspect, the processing circuitry is further configured to update at least one of the first spatial domain filter and the second spatial domain filter based on the at least one indicated TCI state being different from a previously indicated TCI state.

According to one or more embodiments of this aspect, the processing circuitry is further configured to update both the first and second spatial domain filters based on the at least one indicated TCI state indicating a joint TCI state. According to one or more embodiments of this aspect, the processing circuitry is further configured to update the second spatial domain filter based on the at least one indicated TCI state indicating a downlink TCI state. According to one or more embodiments of this aspect, the processing circuitry is further configured to update the first spatial domain filter based on the at least one indicated TCI state indicating an uplink TCI state.

According to one or more embodiments of this aspect, the processing circuitry is further configured to: receive at least one acknowledgement/non-acknowledgement, ACK/NACK, signal associated with at least one physical downlink shared channel, PDSCH, scheduled by the DCI message; and update the at least one indicated TCI state based on a timing associated with the received at least one ACK/NACK signal. According to one or more embodiments of this aspect, the QCL parameter includes at least one of a delay spread parameter, a Doppler parameter, an average delay parameter, a Doppler shift parameter, and a spatial domain receive parameter. According to one or more embodiments of this aspect, each of the plurality of CORESETs is associated with a respective CORESET pool of a plurality of CORESET pools, and each of the plurality of CORESET pools is associated with a respective transmission and reception point, TRP.

According to another aspect of the present disclosure, a wireless device configured to communicate with a network node is provided. The wireless device includes processing circuitry configured to receive at least one first downlink signal from the network node on at least one downlink resource, where the at least one downlink resource belongs to a first control resource set, CORESET, of a plurality of CORESETs. The processing circuitry is further configured to determine a respective CORESET pool index based on the first CORESET. The processing circuitry is further configured to at least one of: receive at least one second downlink signal from the network node, where the at least one second downlink signal is received by the wireless device based on a quasi-colocation, QCL, parameter, and the QCL parameter is associated with the respective CORESET pool index; and cause transmission of at least one uplink signal to the network node, the at least one uplink signal is transmitted based on a first spatial domain filter, and the first spatial domain filter is associated with the respective CORESET pool index.

According to one or more embodiments of this aspect, the at least one second downlink signal is a physical downlink shared channel, PDSCH. According to one or more embodiments of this aspect, receiving the at least one first downlink signal triggers the wireless device to transmit the at least one uplink signal. According to one or more embodiments of this aspect, the at least one first downlink signal includes a downlink control information, DCI, message, and the DCI message includes a transmission configuration indicator, TCI, field that includes a TCI value indicating at least one indicated TCI state. According to one or more embodiments of this aspect, the QCL parameter is further based on the at least one indicated TCI state.

According to one or more embodiments of this aspect, the first spatial domain filter is further based on the at least one indicated TCI state. According to one or more embodiments of this aspect, the TCI value includes at least one TCI field codepoint, and the at least one TCI field codepoint is associated with the at least one indicated TCI state. According to one or more embodiments of this aspect, the at least one TCI field codepoint is mapped to the at least one indicated TCI state based on a format of the first downlink signal. According to one or more embodiments of this aspect, each of the at least one indicated TCI state indicates at least one of a joint TCI state, a downlink TCI state, and an uplink TCI state. According to one or more embodiments of this aspect, receiving the at least one second downlink signal from the network node is based on a downlink beam, the downlink beam is determined based on a second spatial domain filter, and the second spatial domain filter is associated with the respective CORESET pool index.

According to one or more embodiments of this aspect, the processing circuitry is further configured to update at least one of the first spatial domain filter and the second spatial domain filter based on the at least one indicated TCI state being different from a previously indicated TCI state. According to one or more embodiments of this aspect, the processing circuitry is further configured to update both the first and second spatial domain filters based on the at least one indicated TCI state indicating a joint TCI state. According to one or more embodiments of this aspect, the processing circuitry is further configured to update the second spatial domain filter based on the at least one indicated TCI state indicating a downlink TCI state. According to one or more embodiments of this aspect, the processing circuitry is further configured to update the first spatial domain filter based on the at least one indicated TCI state indicating an uplink TCI state.

According to one or more embodiments of this aspect, the processing circuitry is further configured to transmit at least one acknowledgement/non-acknowledgement, ACK/NACK, signal associated with at least one physical downlink shared channel, PDSCH, scheduled by the DCI message, and to update the at least one indicated TCI state based on a timing associated with the transmitted at least one ACK/NACK signal. According to one or more embodiments of this aspect, the QCL parameter includes at least one of a delay spread parameter, a Doppler parameter, an average delay parameter, a Doppler shift parameter, and a spatial domain receive parameter. According to one or more embodiments of this aspect, each of the plurality of CORESETs is associated with a respective CORESET pool of a plurality of CORESET pools, where each of the plurality of CORESET pools is associated with a respective transmission and reception point, TRP.

According to another aspect of the present disclosure, a method implemented by a network node configured to communicate with a wireless device is provided. At least one downlink resource for transmission to the wireless device is determined, where the at least one downlink resource belongs to a first control resource set, CORESET, of a plurality of CORESETs, and the first CORESET is associated with a respective CORESET pool index. At least one first downlink signal is transmitted to the wireless device on the determined at least one downlink resource. At least one second downlink signal is transmitted to the wireless device, where the at least one second downlink signal is received by the wireless device based on a quasi-colocation, QCL, parameter, and the QCL parameter is associated with the CORESET pool index. At least one uplink signal transmitted by the wireless device is received, where the at least one uplink signal is transmitted by the wireless device based on a first spatial domain filter, and the first spatial domain filter is associated with the CORESET pool index.

According to one or more embodiments of this aspect, the at least one second downlink signal is a physical downlink shared channel, PDSCH, and the causing transmission of the at least one second downlink signal is triggered by the first downlink signal. According to one or more embodiments of this aspect, the at least one first downlink signal is configured to cause the wireless device to transmit the at least one uplink signal. According to one or more embodiments of this aspect, the at least one first downlink signal includes a downlink control information, DCI, message, and the DCI message includes a transmission configuration indicator, TCI, field that includes a TCI value indicating at least one indicated TCI state. According to one or more embodiments of this aspect, the QCL parameter is further based on the at least one indicated TCI state.

According to one or more embodiments of this aspect, the first spatial domain filter is further based on the at least one indicated TCI state. According to one or more embodiments of this aspect, wherein the TCI value includes at least one TCI field codepoint, the at least one TCI field codepoint being associated with the at least one indicated TCI state. According to one or more embodiments of this aspect, the at least one TCI field codepoint is mapped to the at least one indicated TCI state based on a format of the at least one first downlink signal. According to one or more embodiments of this aspect, each of the at least one indicated TCI state indicates at least one of a joint TCI state, a downlink TCI state, and an uplink TCI state.

According to one or more embodiments of this aspect, the at least one second downlink signal is received by the wireless device based on a downlink beam, the downlink beam is determined based on a second spatial domain filter, and the second spatial domain filter is associated with the CORESET pool index. According to one or more embodiments of this aspect, at least one of the first spatial domain filter and the second spatial domain filter is updated based on the at least one indicated TCI state being different from a previously indicated TCI state. According to one or more embodiments of this aspect, the both the first and second spatial domain filters are updated based on the at least one indicated TCI state indicating a joint TCI state.

According to one or more embodiments of this aspect, the second spatial domain filter is updated based on the at least one indicated TCI state indicating a downlink TCI state. According to one or more embodiments of this aspect, the first spatial domain filter is updated based on the at least one indicated TCI state indicating an uplink TCI state. According to one or more embodiments of this aspect, at least one acknowledgement/non-acknowledgement, ACK/NACK, signal associated with at least one physical downlink shared channel, PDSCH, scheduled by the DCI message is received, and the at least one indicated TCI state is updated based on a timing associated with the received at least one ACK/NACK signal. According to one or more embodiments of this aspect, the QCL parameter includes at least one of a delay spread parameter, a Doppler parameter, an average delay parameter, a Doppler shift parameter, and a spatial domain receive parameter. According to one or more embodiments of this aspect, each of the plurality of CORESETs is associated with a respective CORESET pool of a plurality of CORESET pools, and each of the plurality of CORESET pools is associated with a respective transmission and reception point, TRP.

According to another aspect of the present disclosure, a method implemented by a wireless device configured to communicate with a network node is provided. At least one first downlink signal is received from the network node on at least one downlink resource, where the at least one downlink resource belongs to a first control resource set, CORESET, of a plurality of CORESETs. A respective CORESET pool index is determined based on the first CORESET. At least one second downlink signal is received from the network node, where the at least one second downlink signal is received by the wireless device based on a quasi-colocation, QCL, parameter, and the QCL parameter is associated with the respective CORESET pool index. At least one uplink signal is transmitted to the network node, where the at least one uplink signal is transmitted based on a first spatial domain filter, and the first spatial domain filter is associated with the respective CORESET pool index.

According to one or more embodiments of this aspect, the at least one second downlink signal is a physical downlink shared channel, PDSCH. According to one or more embodiments of this aspect, receiving the at least one first downlink signal triggers the wireless device to transmit the at least one uplink signal. According to one or more embodiments of this aspect, the at least one first downlink signal includes a downlink control information, DCI, message, and the DCI message includes a transmission configuration indicator, TCI, field that includes a TCI value indicating at least one indicated TCI state. According to one or more embodiments of this aspect, the QCL parameter is further based on the at least one indicated TCI state.

According to one or more embodiments of this aspect, the first spatial domain filter is further based on the at least one indicated TCI state. According to one or more embodiments of this aspect, the TCI value includes at least one TCI field codepoint, and the at least one TCI field codepoint is associated with the at least one indicated TCI state. According to one or more embodiments of this aspect, the at least one TCI field codepoint is mapped to the at least one indicated TCI state based on a format of the first downlink signal. According to one or more embodiments of this aspect, each of the at least one indicated TCI state indicates at least one of a joint TCI state, a downlink TCI state, and an uplink TCI state. According to one or more embodiments of this aspect, receiving the at least one second downlink signal from the network node is based on a downlink beam, the downlink beam is determined based on a second spatial domain filter, and the second spatial domain filter is associated with the respective CORESET pool index.

According to one or more embodiments of this aspect, at least one of the first spatial domain filter and the second spatial domain filter is updated based on the at least one indicated TCI state being different from a previously indicated TCI state. According to one or more embodiments of this aspect, both the first and second spatial domain filters are updated based on the at least one indicated TCI state indicating a joint TCI state. According to one or more embodiments of this aspect, the second spatial domain filter is updated based on the at least one indicated TCI state indicating a downlink TCI state. According to one or more embodiments of this aspect, the first spatial domain filter is updated based on the at least one indicated TCI state indicating an uplink TCI state.

According to one or more embodiments of this aspect, at least one acknowledgement/non-acknowledgement, ACK/NACK, signal associated with at least one physical downlink shared channel, PDSCH, scheduled by the DCI message is transmitted, and at least one indicated TCI state is updated based on a timing associated with the transmitted at least one ACK/NACK signal. According to one or more embodiments of this aspect, the QCL parameter includes at least one of a delay spread parameter, a Doppler parameter, an average delay parameter, a Doppler shift parameter, and a spatial domain receive parameter. According to one or more embodiments of this aspect, each of the plurality of CORESETs is associated with a respective CORESET pool of a plurality of CORESET pools, where each of the plurality of CORESET pools is associated with a respective transmission and reception point, TRP.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of a two-stage TCI state update (the selected TCI state is selected from the activated set of TCI states using DCI, and the set of activated TCI states is updated using MAC CE);

FIG. 2 illustrates an example of TCI States Activation/Deactivation for wireless device-specific PDSCH MAC CE (from FIG. 6.1.3.14-1 of 3GPP TS 38.321);

FIG. 3 illustrates an example of DCI indication of a TCI state (the DCI gives a pointer into the ordered list of activated TCI states);

FIG. 4 illustrates an example of Enhanced TCI States Activation/Deactivation for wireless device-specific PDSCH MAC CE;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a flowchart of another example process in a network node according to some embodiments of the present disclosure;

FIG. 14 is a flowchart of another example process in a wireless device according to some embodiments of the present disclosure;

FIG. 15 illustrates an example of activated TCI states and their associated TCI field codepoints in DCI for Joint DL/UL TCI operation according to some embodiments;

FIG. 16 illustrates an example of activated TCI states and their associated TCI field codepoints in DCI for separate DL/UL TCI operation according to some embodiments;

FIG. 17a illustrates an example of Activating/mapping DL and UL TCI states separately to TCI field of DCI in different DCI formats according to some embodiments;

FIG. 17b illustrates another example of Activating/mapping DL and UL TCI states separately to TCI field of DCI in different DCI formats according to some embodiments;

FIG. 18 illustrates an example of one codepoint of TCI field in DCI is not mapped to any TCI state according to some embodiments;

FIG. 19 illustrates an example showing a wireless device configured with two subsets of CORESETs with each subset of CORESETs associated with a CORESETPoolIndex and a common beam according to some embodiments;

FIG. 20 illustrates an example showing update of TCI state corresponding to one of the CORESET Pools according to some embodiments;

FIG. 21 illustrates an example of time of TCI state update corresponding to both the CORESET Pools according to some embodiments;

FIG. 22 illustrates a second example showing time of TCI state update corresponding to both the CORESET Pools according to some embodiments;

FIG. 23 illustrates a third example showing time of TCI state update corresponding to both the CORESET Pools according to some embodiments; and

FIG. 24 illustrates a fourth example showing time of TCI state update corresponding to both the CORESET Pools according to some embodiments.

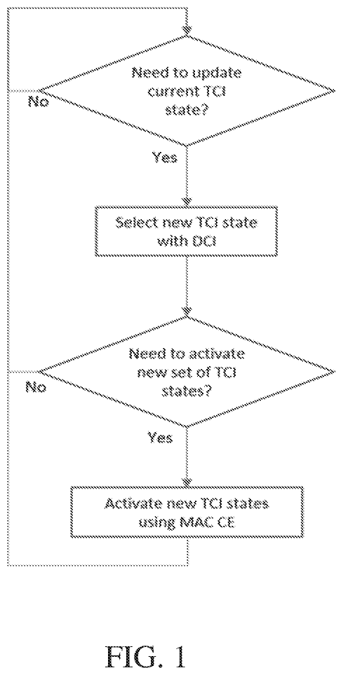

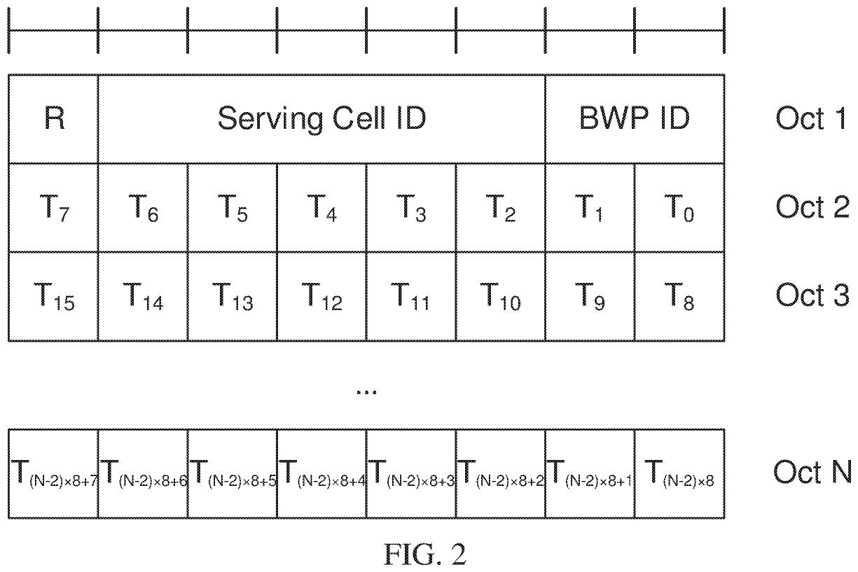

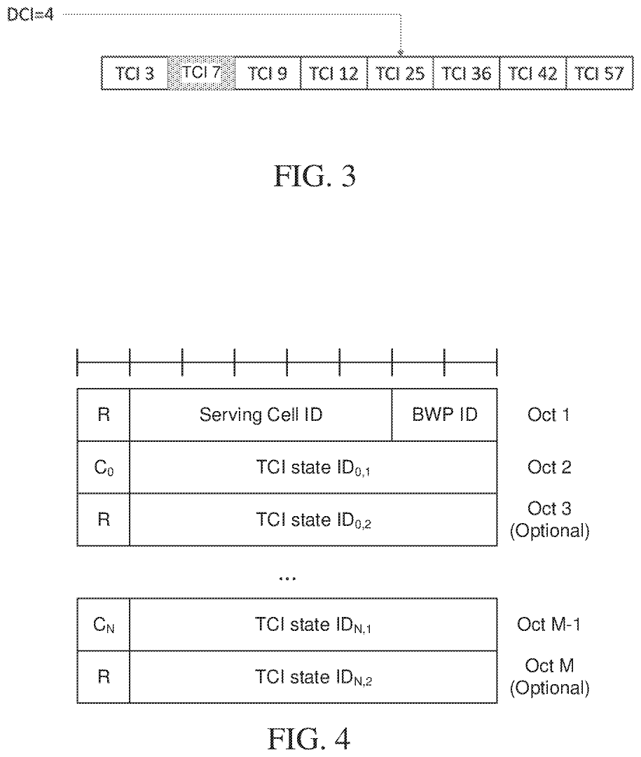

### DETAILED DESCRIPTION

The focus of recent 3GPP Rel-17 discussions has been, for example, on TCI state updates for single TRP. However, how to update TCI states for multi-DCI based multi-TRP operation is still an open issue that needs to be solved. This disclosure provides example solutions.

Some embodiments in this disclosure involve one or more of the following embodiments:
the first embodiment relates to how transmit/receive spatial filters are associated with CORESET pools and/or details of which channels/signals the transmit/receive spatial filters specific to CORESET pools may be applied;
the second embodiment relates to details of how indication for update of transmit/receive spatial filters associated with CORESET pool(s) are received by the wireless device; and/or
the third embodiment covers update of transmit/receive spatial filters associated with CORESET pool(s).

Some aspects of the embodiments are detailed below, which may be performed by one or more of network node and wireless device described herein:
Associate joint/DL/UL TCI state to each CORESET Pool Index; hence, the wireless device maintains separate transmit and/or receive spatial filters per CORESET Pool Index.
Update TCI state of all channels/reference signals associated with a CORESET Pool A, when the wireless device receives a DCI including a TCI field codepoint in a PDCCH that is received in a CORESET that belongs to CORESET Pool A. Which DL/UL signals/channels associated with CORESET Pool A that the indicated TCI states should be applied to depends on what kind of TCI states the TCI field codepoint indicates:
   If indicated TCI state is a joint TCI state, then the wireless device updates both the transmit and receive spatial filters associated with CORESET Pool A (for the DL/UL channels/signals that are associated/configured with the new unified TCI state framework).
   If indicated TCI state is a DL TCI state, then the wireless device updates the receive spatial filters associated with CORESET Pool A (for the DL channels/signals that are associated/configured with the new unified TCI state framework).
   If indicated TCI state is an UL TCI state, then the wireless device updates the transmit spatial filters associated with CORESET Pool A (for the UL channels/signals that are associated with the new unified TCI state framework).
   If the TCI field codepoints indicates one DL TCI state and one UL TCI state, then the wireless device updates the receive spatial filters associated with CORESET Pool A according to the indicated DL TCI state (for the DL channels/signals that are associated/configured with the new unified TCI state framework) and the wireless device updates the transmit spatial filters associated with CORESET Pool A according to the indicated UL TCI state (for the UL channels/signals that are associated/configured with the new unified TCI state framework).
In some embodiments, details of when the spatial filter updates happen at the wireless device as provided:
   If separate acknowledgement/non-acknowledgement (ACK/NACK) are used for the PDSCHs scheduled by the DCIs corresponding to the two CORESET Pools, then the spatial filters corresponding to the two CORESET Pools may be independently updated (possibly at different times).
   If joint ACK/NACK feedback is used for the PDSCHs scheduled by the DCIs corresponding to the two CORESET Pools, then the spatial filters corresponding to the two CORESET Pools may be updated jointly (at the same time).

Some embodiments may provide one or more of the following advantages:
Some embodiments extend the new unified TCI framework to handle multi-DCI multi-TRP operation; in particular, by associating channels and signals to a CORESET pool, it allows a common beam to be applied to the channels and signals associated with each CORESET pool such that there can be one common beam per TRP (where TRP is represented by a CORESET Pool index).
In some embodiments, with implicitly indicating a CORESET pool for which DL/UL TCI state is to be updated by a DCI by the CORESET in which the DCI is received, wireless device knows which CORESET Pool's TCI state is to be updated upon receiving the DCI indicating TCI state update. Furthermore, it provides an efficient TCI state update mechanism since transmit/receive filters for transmitting/receiving all channels/signals associated with the CORESET Pool index get updated via single DCI. This also saves signaling overhead for beam update in the multi-DCI based multi-TRP deployment.

Before describing in detail example embodiments, it is noted that the embodiments reside primarily in combinations of apparatus components and processing steps related to common spatial filter updates for multi-DCI based multi-TRP systems. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, one of A and B corresponds to A or B. In some embodiments, at least one of A and B corresponds to A, B or AB, or to one or more of A and B. In some embodiments, at least one of A, B and C corresponds to one or more of A, B and C, or A, B, C or any combination thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device such as a wireless device or a radio network node.

In some embodiments, the non-limiting terms wireless device or a user equipment (UE) are used interchangeably. The wireless device herein can be any type of wireless device capable of communicating with a network node or another wireless device over radio signals, such as wireless device. The wireless device may also be a radio communication device, target device, device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the wireless device. For the UL communication, the transmitter is the wireless device and the receiver is the network node.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ). Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the wireless device in measurement gaps unless the wireless device is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the wireless device by the network node.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages (e.g., TCI field, etc.). It may be considered that receiving control signaling comprises demodulating and/or decoding and/or detecting. e.g., blind detection of, one or more messages, in particular a message carried by the control signaling, e.g., based on an assumed set of resources, which may be searched and/or listened for the control information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., index value, configuration information, a predetermined information, a table, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. Examples of channels comprise a channel for low latency and/or high reliability transmission, in particular a channel for Ultra-Reliable Low Latency Communication (URLLC), which may be for control and/or data. In some embodiments, the channel described herein may be an uplink channel and in further embodiments may be a physical uplink shared channel (PUSCH) and in yet further embodiments may be a flexible PUSCH.

Transmitting in downlink may pertain to transmission from the network or network node to the terminal. The terminal may be considered the wireless device or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device (e.g., the indication of the resource allocation as discussed above). Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

### Configuring a Radio Node

Configuring a radio node, in particular a terminal or user equipment or the wireless device, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., wireless device) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., wireless device) may comprise configuring the wireless device to perform certain measurements on certain subframes or radio resources and reporting such measurements according to embodiments of the present disclosure.

The term time used herein may correspond to any type of physical resource or radio resource expressed in terms of length of time. Examples of time resources are: symbol, time slot, sub-slot, subframe, radio frame, sub-frame, TTI, interleaving time, a time resource number, etc.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE or NR standard. One or more carriers (e.g., uplink and/or downlink carrier/s and/or a carrier for both uplink and downlink) may be associated to a cell.

A physical channel is a channel of a physical layer that transmits a modulation symbol obtained by modulating at least one coded bit stream. An Orthogonal Frequency Division Multiple Access (OFDMA) system generates and transmits multiple physical channels according to the use of a transmission information stream or the receiver. A transmitter and a receiver may previously agree on the rule for determining for which resource elements (REs) the transmitter and receiver will arrange one physical channel during transmission on the REs, and this rule may be called ‘mapping’.

Predefined in the context of this disclosure may refer to the related information being defined for example in a standard, and/or being available without specific configuration from a network or network node, e.g., stored in memory, for example independent of being configured. Configured or configurable may be considered to pertain to the corresponding information being set/configured, e.g., by the network or a network node.

In some embodiments, a “subset” as used herein may be a set or subset of 1 or more elements in the set/subset. In other embodiments, a “subset” as used herein may be a set or subset of 2 or more elements in the set/subset.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

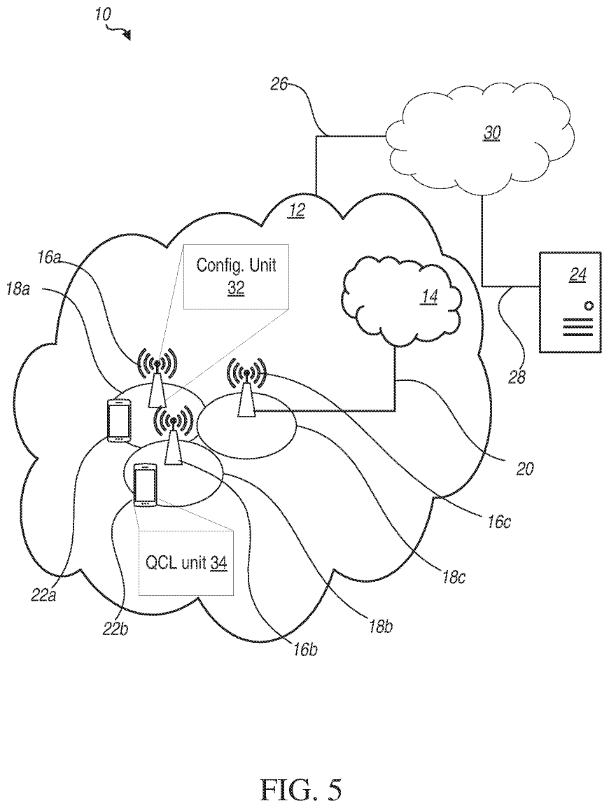

Some embodiments provide arrangements for common spatial filter updates for multi-DCI based multi-TRP systems. Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device 22a located in coverage area 18a is configured to wirelessly connect to, or be paged by, the corresponding network node 16a. A second wireless device 22b in coverage area 18b is wirelessly connectable to the corresponding network node 16b. While a plurality of wireless devices 22a, 22b (collectively referred to as wireless devices 22) are illustrated in this example, the disclosed embodiments are equally applicable to a situation where a sole wireless device is in the coverage area or where a sole wireless device is connecting to the corresponding network node 16. Note that although only two wireless devices 22 and three network nodes 16 are shown for convenience, the communication system may include many more wireless devices 22 and network nodes 16.

Also, it is contemplated that a wireless device 22 can be in simultaneous communication and/or configured to separately communicate with more than one network node 16 and more than one type of network node 16. For example, a wireless device 22 can have dual connectivity with a network node 16 that supports LTE and the same or a different network node 16 that supports NR. As an example, wireless device 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected wireless devices 22a, 22b and the host computer 24. The connectivity may be described as an over-the-top (OTT) connection. The host computer 24 and the connected wireless devices 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected wireless device 22a. Similarly, the network node 16 need not be aware of the future routing of an outgoing uplink communication originating from the wireless device 22a towards the host computer 24.

A network node 16 is configured to include a configuration (config.) unit 32 which is configured to cause the network node (NN) 16 to one or more of: transmit information associating at least one first reference signal and/or at one first channel to at least a first subset of control resource sets (CORESETs); transmit information associating at least one second reference signal and/or at least one second channel to at least a second subset of CORESETs; transmit a downlink control information (DCI) on a physical downlink control channel (PDCCH) in a CORESET to the wireless device 22; and transmit to and/or receive signaling from the wireless device 22, the signaling being transmitted/received based at least in part on quasi-colocation (QCL) information, the QCL information being based at least in part on which one of the first and second subset of CORESETs that the CORESET the DCI is transmitted on belongs to.

A wireless device 22 is configured to include a QCL unit 34 which is configured to case the wireless device 22 to one or more of: receive information associating at least one first reference signal and/or at one first channel to at least a first subset of control resource sets (CORESETs); receive information associating at least one second reference signal and/or at least one second channel to at least a second subset of CORESETs; receive a downlink control information (DCI) on a physical downlink control channel (PDCCH) in a CORESET to the wireless device 22; and transmit and/or receive signaling, the signaling being transmitted/received based at least in part on quasi-colocation (QCL) information, the QCL information being based at least in part on which one of the first and second subset of CORESETs that the CORESET the DCI is received on belongs to.

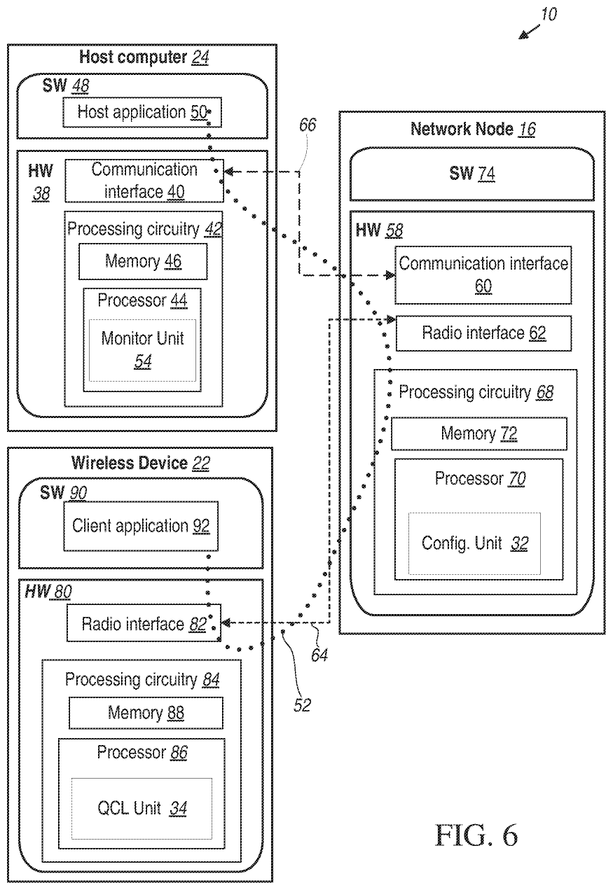

Example implementations, in accordance with an embodiment, of the wireless device 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a wireless device 22 connecting via an OTT connection 52 terminating at the wireless device 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the wireless device 22. The hardware 58 may include a communication interface 60 for setting up and maintaining a wired or wireless connection with an interface of a different communication device of the communication system 10, as well as a radio interface 62 for setting up and maintaining at least a wireless connection 64 with a wireless device 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

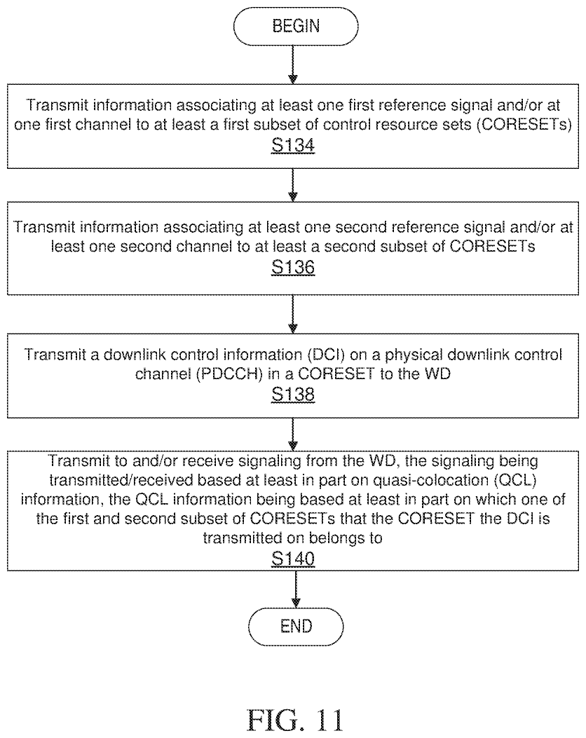

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include config, unit 32 configured to perform network node methods discussed herein, such as the methods discussed with reference to FIG. 11 as well as other figures.

The communication system 10 further includes the wireless device 22 already referred to. The wireless device 22 may have hardware 80 that may include a radio interface 82 configured to set up and maintain a wireless connection 64 with a network node 16 serving a coverage area 18 in which the wireless device 22 is currently located. The radio interface 82 may be formed as or may include, for example, one or more RF transmitters, one or more RF receivers, and/or one or more RF transceivers.

The hardware 80 of the wireless device 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the wireless device 22 may further comprise software 90, which is stored in, for example, memory 88 at the wireless device 22, or stored in external memory (e.g., database, storage array, network storage device, etc.) accessible by the wireless device 22. The software 90 may be executable by the processing circuitry 84. The software 90 may include a client application 92. The client application 92 may be operable to provide a service to a human or non-human user via the wireless device 22, with the support of the host computer 24. In the host computer 24, an executing host application 50 may communicate with the executing client application 92 via the OTT connection 52 terminating at the wireless device 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

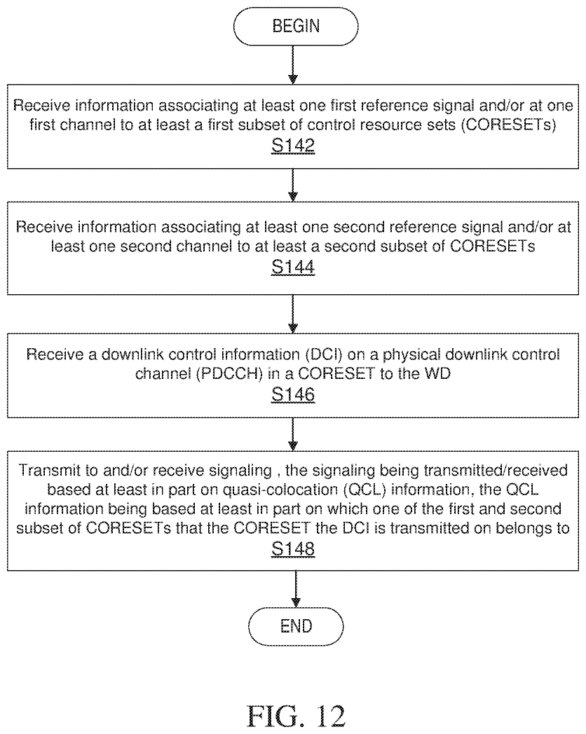

The processing circuitry 84 may be configured to control any of the methods and/or processes described herein and/or to cause such methods, and/or processes to be performed, e.g., by wireless device 22. The processor 86 corresponds to one or more processors 86 for performing wireless device 22 functions described herein. The wireless device 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to wireless device 22. For example, the processing circuitry 84 of the wireless device 22 may include a QCL unit 34 configured to perform wireless device methods discussed herein, such as the methods discussed with reference to FIG. 12 as well as other figures.

In some embodiments, the inner workings of the network node 16, wireless device 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the wireless device 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the wireless device 22 and the network node 16 is in accordance with the teachings of the embodiments described throughout this disclosure. One or more of the various embodiments improve the performance of OTT services provided to the wireless device 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and wireless device 22, in response to variations in the measurement results. The measurement procedure and/or the network functionality for reconfiguring the OTT connection 52 may be implemented in the software 48 of the host computer 24 or in the software 90 of the wireless device 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary wireless device signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the wireless device 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the wireless device 22, and/or preparing/terminating/maintaining/supporting/ending in receipt of a transmission from the wireless device 22.

In some embodiments, the host computer 24 includes processing circuitry 42 and a communication interface 40 that is configured to a communication interface 40 configured to receive user data originating from a transmission from a wireless device 22 to a network node 16. In some embodiments, the wireless device 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as config, unit 32, and QCL unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

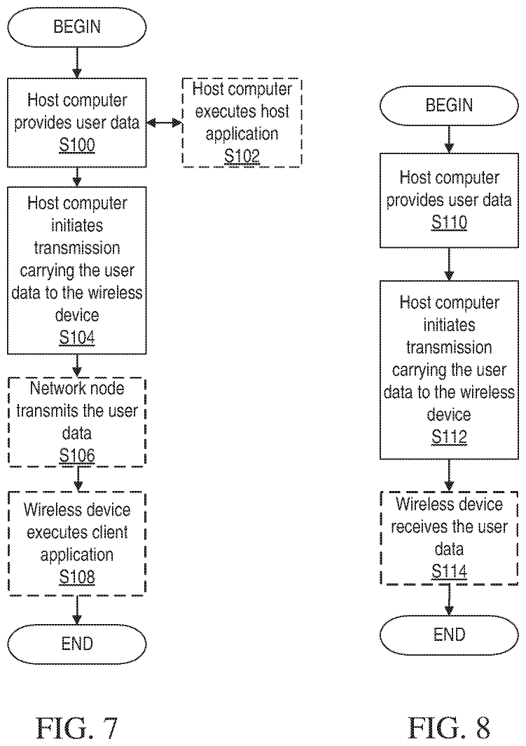

FIG. 7 is a flowchart illustrating an example method implemented in a communication system, such as, for example, the communication system of FIGS. 5 and 6, in accordance with one embodiment. The communication system may include a host computer 24, a network node 16 and a wireless device 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the wireless device 22 (Block S104). In an optional third step, the network node 16 transmits to the wireless device 22 the user data which was carried in the transmission that the host computer 24 initiated, in accordance with the teachings of the embodiments described throughout this disclosure (Block S106). In an optional fourth step, the wireless device 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a wireless device 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the wireless device 22 (Block S112). The transmission may pass via the network node 16, in accordance with the teachings of the embodiments described throughout this disclosure. In an optional third step, the wireless device 22 receives the user data carried in the transmission (Block S114).

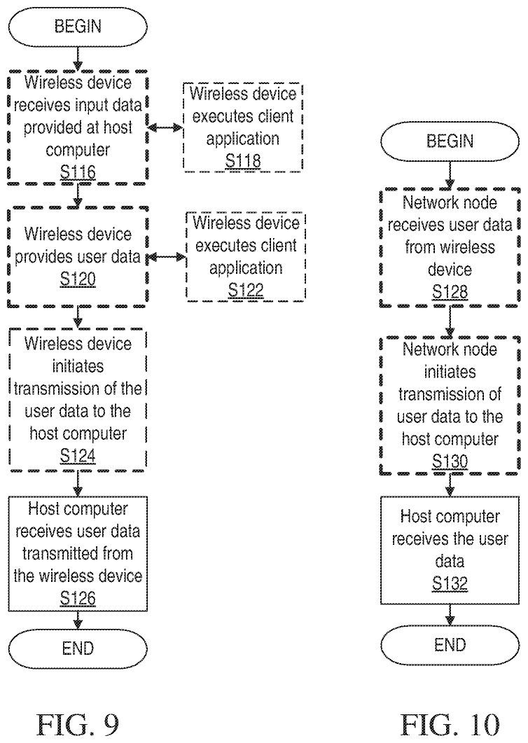

FIG. 9 is a flowchart illustrating an example method implemented in a communication system, such as, for example, the communication system of FIG. 5, in accordance with one embodiment. The communication system may include a host computer 24, a network node 16 and a wireless device 22, which may be those described with reference to FIGS. 5 and 6. In an optional first step of the method, the wireless device 22 receives input data provided by the host computer 24 (Block S116). In an optional substep of the first step, the wireless device 22 executes the client application 92, which provides the user data in reaction to the received input data provided by the host computer 24 (Block S118). Additionally or alternatively, in an optional second step, the wireless device 22 provides user data (Block S120). In an optional substep of the second step, the wireless device provides the user data by executing a client application, such as, for example, client application 92 (Block S122). In providing the user data, the executed client application 92 may further consider user input received from the user. Regardless of the specific manner in which the user data was provided, the wireless device 22 may initiate, in an optional third substep, transmission of the user data to the host computer 24 (Block S124). In a fourth step of the method, the host computer 24 receives the user data transmitted from the wireless device 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a wireless device 22, which may be those described with reference to FIGS. 5 and 6. In an optional first step of the method, in accordance with the teachings of the embodiments described throughout this disclosure, the network node 16 receives user data from the wireless device 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 11 is a flowchart of an example process in a network node 16 according to some embodiments of the present disclosure. One or more Blocks and/or functions and/or methods performed by the network node 16 may be performed by one or more elements of network node 16 such as by config, unit 32 in processing circuitry 68, processor 70, radio interface 62, etc. according to the example method. The example method includes transmitting (Block S134), such as via network node 16, information associating at least one first reference signal and/or at one first channel to at least a first subset of control resource sets (CORESETs). The method includes transmitting (Block S136), such as via network node 16, information associating at least one second reference signal and/or at least one second channel to at least a second subset of CORESETs. The method includes transmitting (Block S138), such as via network node 16, a downlink control information (DCI) on a physical downlink control channel (PDCCH) in a CORESET to the wireless device 22 22. The method includes transmitting to and/or receiving (Block S140), such as via network node 16, signaling from the wireless device 22, the signaling being transmitted/received based at least in part on quasi-colocation (QCL) information, the QCL information being based at least in part on which one of the first and second subset of CORESETs that the CORESET the DCI is transmitted on belongs to.

In some embodiments, the DCI comprises a transmission configuration indicator (TCI) field comprising a value indicating at least one TCI state, the QCL information being determined from and/or based at least in part on the indicated at least one TCI state. In some embodiments, the signaling is transmitted/received based at least in part on a spatial domain filter, the spatial domain filter being based at least in part on which one of the first and second subset of CORESETs that the CORESET the DCI is transmitted on belongs to. In some embodiments, the signaling is a beam transmitted/received based at least in part on the spatial domain filter associated with the one the first and second subset of CORESETs that the CORESET the DCI is transmitted on belongs to. In some embodiments, the spatial domain filter comprises at least one of a spatial domain transmit filter and a spatial domain receive filter.

In some embodiments, the signaling transmitted to the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI. In some embodiments, the signaling received from the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

In some embodiments, the transmitted signaling comprises at least one of a physical downlink shared channel (PDSCH), a reference signal (RS) and a CSI-RS. In some embodiments, the received signaling comprises at least one of an acknowledgement/non-acknowledgement (ACK/NACK), a sounding reference signal (SRS) and a physical uplink shared channel (PUSCH).

In some embodiments, which one or more of the at least one first and second reference signals and/or the at least one first and second channels that the indicated at least one TCI state applies to/is updated by is based at least in part on a type of the at least one TCI state. In some embodiments, the type of the at least one TCI state comprises at least one of a joint TCI state, a downlink (DL) TCI state and an uplink (UL) TCI state.

In some embodiments, if the type of an indicated TCI state comprises the joint TCI state, the indicated TCI state applies to/updates both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

In some embodiments, if the type of an indicated TCI state is the DL TCI state, the indicated TCI state applies to/updates the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

In some embodiments, if the type of an indicated TCI state is the UL TCI state, the indicated TCI state applies to/updates the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

In some embodiments, spatial domain filters are updated at the wireless device 22 only if the indicated TCI state is different from an active TCI state that is associated with the one of the first and second subset of CORESETs that the CORESET the DCI is transmitted on belongs to. In some embodiments, the value comprised in the TCI field in the DCI is a TCI field codepoint out of a plurality of TCI field codepoints, the TCI field codepoint indicating the at least one TCI state out of a plurality of TCI states configured to the wireless device 22. In some embodiments, the value comprised in the DCI is one of a joint UL/DL TCI state beam indication, a downlink (DL) TCI state beam indication and an uplink (UL) TCI state beam indication.

In some embodiments, one of the plurality of TCI field codepoints configured to the wireless device 22 indicates that there is no TCI state update. In some embodiments, the at least one TCI state that is indicated by the TCI field codepoint is based at least in part on a DCI format of the DCI transmitted on the PDCCH. In some embodiments, if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

In some embodiments, the method further includes transmitting, such as via network node 16, configuration information to the wireless device 22, the configuration information configuring the wireless device 22 with a plurality of CORESETs, the first subset of CORESETs being associated with a first CORESET pool index value and the second subset of CORESETs being associated with a second CORESET pool index value. In some embodiments, the first and second subsets are disjoint sets.

In some embodiments, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index. In some embodiments, the association of the at least one first reference signal and/or the at one first channel to the first subset of CORESETs and the association of the at least one second reference signal and/or the at one second channel to the second subset of CORESETs is via a radio resource control (RRC) configuration, such as via network node 16. In some embodiments, the RRC configuration comprises a channel/signal resource configuration comprising an index value identifying the one of the first and second subsets of CORESETs to be associated with the channel/signal resource.

In some embodiments, the association of the at least one first reference signal and/or the at one first channel to the first subset of CORESETs and the association of the at least one second reference signal and/or the at one second channel to the second subset of CORESETs is via a medium access control (MAC) control element (CE), such as via network node 16. In some embodiments, the MAC CE indicates a channel/signal resource associated with one of the first and second subsets of CORESETs to be associated with the channel/signal resource. In some embodiments, the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources.

In some embodiments, the RRC configuration information comprises a plurality of CORESET pool index values, each index value identifying a corresponding subset of CORESETs and indicating at least one reference signal/channel associated with the respective index value. In some embodiments, the method further includes activating, such as via network node 16, TCI states in a MAC CE, the activated TCI states being mapped to TCI field codepoints. In some embodiments, the activated TCI states comprising one of a joint TCI state, a DL TCI state and an UL TCI state. In some embodiments, the one of the joint TCI state, the DL TCI state and the UL TCI state is activated per corresponding CORESET subset and/or per corresponding CORESET pool index value.

In some embodiments, the receiving signaling comprises receiving, such as via network node 16, at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one received ACK/NACK. In some embodiments, the receiving signaling comprises receiving, such as via network node 16, separate acknowledgements/non-acknowledgements (ACK/NACKs) for physical downlink shared channels (PDSCHs) scheduled by the DCI and/or another DCI.

In some embodiments, the receiving signaling comprises receiving, such as via network node 16, joint acknowledgements/non-acknowledgements (ACK/NACKs) for physical downlink shared channels (PDSCHs) scheduled by the DCI and/or another DCI. In some embodiments, the QCL information and/or spatial domain filters associated with the corresponding subset of CORESETs are independently updated at the wireless device 22 at different times. In some embodiments, the time of the update is associated with the corresponding subset of CORESETs and/or the corresponding index value identifying the subset. In some embodiments, the QCL information and/or spatial domain filters associated with the corresponding subset of CORESETs are jointly updated at the wireless device 22 at a same time.

In some embodiments, the at least one first and second reference signals and/or the at least one first and second channels associated with the first and second subsets of CORESETs configured to the wireless device 22 are also associated with different cell identifiers (IDs). In some embodiments, the different cell IDs are associated with multiple transmit receive points (TRPs), the multiple TRPs being associated with one or more network nodes in communication with the wireless device 22. In some embodiments, the QCL information is indicated via a transmission configuration indicator (TCI) state. In some embodiments, the QCL information comprises at least one of a delay spread parameter, a Doppler parameter, an average delay parameter, a Doppler shift parameter, a spatial domain receive parameter and a spatial domain transmit parameter.

FIG. 12 is a flowchart of an example process in a wireless device 22 according to some embodiments of the present disclosure. One or more Blocks and/or functions and/or methods performed by wireless device 22 may be performed by one or more elements of wireless device 22 such as by QCL unit 34 in processing circuitry 84, processor 86, radio interface 82, etc. The example method includes receiving (Block S142), such as via wireless device 22, information associating at least one first reference signal and/or at one first channel to at least a first subset of control resource sets (CORESETs). The method includes receiving (Block S144), such as via wireless device 22, information associating at least one second reference signal and/or at least one second channel to at least a second subset of CORESETs. The method includes receiving (Block S146), such as via wireless device 22, a downlink control information (DCI) on a physical downlink control channel (PDCCH) in a CORESET to the wireless device 22. The method includes transmitting and/or receiving (Block S148), such as via wireless device 22, signaling, the signaling being transmitted/received based at least in part on quasi-colocation (QCL) information, the QCL information being based at least in part on which one of the first and second subset of CORESETs that the CORESET the DCI is received on belongs to.

In some embodiments, the DCI comprises a transmission configuration indicator (TCI) field comprising a value indicating at least one TCI state, the QCL information being determined from and/or based at least in part on the indicated at least one TCI state. In some embodiments, the signaling is transmitted/received, such as via wireless device 22, based at least in part on a spatial domain filter, the spatial domain filter being based at least in part on which one of the first and second subset of CORESETs that the CORESET the DCI is received on belongs to. In some embodiments, the signaling is a beam transmitted/received, such as via wireless device 22, based at least in part on the spatial domain filter associated with the one the first and second subset of CORESETs that the CORESET the DCI is received on belongs to. In some embodiments, the spatial domain filter comprises at least one of a spatial domain transmit filter and a spatial domain receive filter.

In some embodiments, the signaling received by the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI. In some embodiments, the signaling transmitted by the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

In some embodiments, the received signaling comprises at least one of a physical downlink shared channel (PDSCH), a reference signal (RS) and a CSI-RS that is related to and/or triggered by the received DCI. In some embodiments, the transmitted signaling comprises at least one of an acknowledgement/non-acknowledgement (ACK/NACK), a sounding reference signal (SRS) and a physical uplink shared channel (PUSCH) that is related to and/or triggered by the received DCI.

In some embodiments, which one or more of the at least one first and second reference signals and/or the at least one first and second channels that the indicated at least one TCI state applies to/is updated by is based at least in part on a type of the at least one TCI state. In some embodiments, the type of the at least one TCI state comprises at least one of a joint TCI state, a downlink (DL) TCI state and an uplink (UL) TCI state.

In some embodiments, if the type of an indicated TCI state comprises the joint TCI state, the indicated TCI state applies to/updates at the wireless device 22 both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

In some embodiments, if the type of an indicated TCI state is the DL TCI state, the indicated TCI state applies to/updates at the wireless device 22 the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

In some embodiments, if the type of an indicated TCI state is the UL TCI state, the indicated TCI state applies to/updates at the wireless device 22 the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

In some embodiments, spatial domain filters are updated by the wireless device 22 only if the indicated TCI state is different from an active TCI state that is associated with the one of the first and second subset of CORESETs that the CORESET the DCI is received on belongs to. In some embodiments, the value comprised in the TCI field in the DCI is a TCI field codepoint out of a plurality of TCI field codepoints, the TCI field codepoint indicating the at least one TCI state out of a plurality of TCI states configured to the wireless device 22. In some embodiments, the value comprised in the DCI is one of a joint UL/DL TCI state beam indication, a downlink (DL) TCI state beam indication and an uplink (UL) TCI state beam indication. In some embodiments, one of the plurality of TCI field codepoints configured to the wireless device 22 indicates that there is no TCI state update. In some embodiments, the at least one TCI state that is indicated by the TCI field codepoint is based at least in part on a DCI format of the DCI received on the PDCCH.

In some embodiments, if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

In some embodiments, the method further includes receiving, such as via wireless device 22, configuration information, the configuration information configuring the method with a plurality of CORESETs, the first subset of CORESETs being associated with a first CORESET pool index value and the second subset of CORESETs being associated with a second CORESET pool index value. In some embodiments, the first and second subsets are disjoint sets.

In some embodiments, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index.

In some embodiments, the association of the at least one first reference signal and/or the at one first channel to the first subset of CORESETs and the association of the at least one second reference signal and/or the at one second channel to the second subset of CORESETs is via a radio resource control (RRC) configuration received by the wireless device 22. In some embodiments, the RRC configuration comprises a channel/signal resource configuration comprising an index value identifying the one of the first and second subsets of CORESETs to be associated with the channel/signal resource.

In some embodiments, the association of the at least one first reference signal and/or the at one first channel to the first subset of CORESETs and the association of the at least one second reference signal and/or the at one second channel to the second subset of CORESETs is via a medium access control (MAC) control element (CE) received by the wireless device 22. In some embodiments, the MAC CE indicates a channel/signal resource associated with one of the first and second subsets of CORESETs to be associated with the channel/signal resource. In some embodiments, the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources. In some embodiments, the RRC configuration information comprises a plurality of CORESET pool index values, each index value identifying a corresponding subset of CORESETs and indicating at least one reference signal/channel associated with the respective index value.

In some embodiments, the method further includes receiving, such as via wireless device 22, an activation of TCI states in a MAC CE, the activated TCI states being mapped to TCI field codepoints; and the activated TCI states comprising one of a joint TCI state, a DL TCI state and an UL TCI state. In some embodiments, the one of the joint TCI state, the DL TCI state and the UL TCI state is activated per corresponding CORESET subset and/or per corresponding CORESET pool index value.

In some embodiments, the method further includes transmitting, such as via wireless device 22, at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one transmitted ACK/NACK. In some embodiments, the method further includes transmitting, such as via wireless device 22, separate acknowledgements/non-acknowledgements (ACK/NACKs) for physical downlink shared channels (PDSCHs) scheduled by the DCI and/or another DCI.

In some embodiments, the method further includes transmitting, such as via wireless device 22, joint acknowledgements/non-acknowledgements (ACK/NACKs) for physical downlink shared channels (PDSCHs) scheduled by the DCI and/or another DCI. In some embodiments, the QCL information and/or spatial domain filters associated with the corresponding subset of CORESETs are independently updated at the wireless device 22 at different times. In some embodiments, the time of the update at the wireless device 22 is associated with the corresponding subset of CORESETs and/or the corresponding index value identifying the subset. In some embodiments, the QCL information and/or spatial domain filters associated with the corresponding subset of CORESETs are jointly updated at the wireless device 22 at a same time.

In some embodiments, the at least one first and second reference signals and/or the at least one first and second channels associated with the first and second subsets of CORESETs configured to the wireless device 22 are also associated with different cell identifiers (IDs). In some embodiments, the different cell IDs are associated with multiple transmit receive points (TRPs), the multiple TRPs being associated with one or more network nodes in communication with the wireless device 22. In some embodiments, the QCL information is indicated via a transmission configuration indicator (TCI) state. In some embodiments, the QCL information comprises at least one of a delay spread parameter, a Doppler parameter, an average delay parameter, a Doppler shift parameter, a spatial domain receive parameter and a spatial domain transmit parameter.

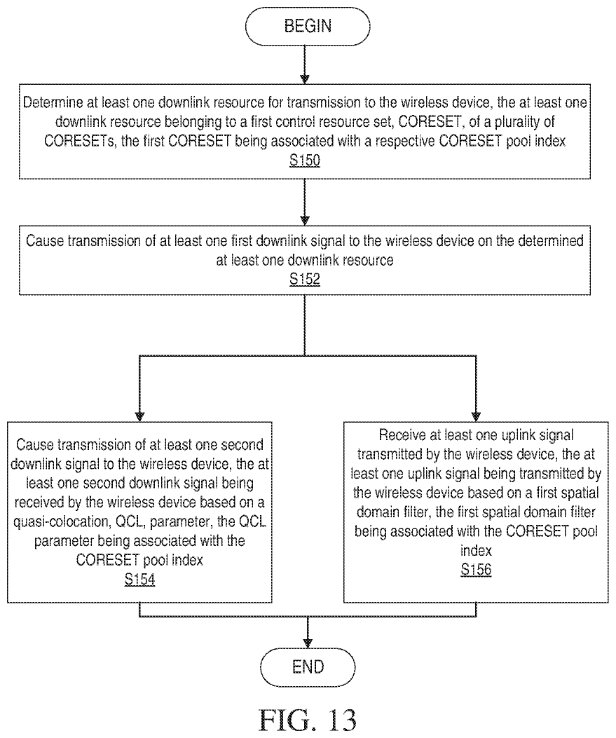

FIG. 13 is a flowchart of an example process in a network node 16 according to some embodiments of the present disclosure. One or more Blocks and/or functions and/or methods performed by the network node 16 may be performed by one or more elements of network node 16 such as by config, unit 32 in processing circuitry 68, processor 70, radio interface 62, etc. according to the example method. The network node 16 is configured to determine (Block S150) at least one downlink resource for transmission to the wireless device 22, where the at least one downlink resource belongs to a first control resource set, CORESET, of a plurality of CORESETs, and the first CORESET is associated with a respective CORESET pool index. The network node 16 is further configured to cause transmission (Block S152) of at least one first downlink signal to the wireless device on the determined at least one downlink resource. The network node 16 is further configured to at least one of: cause transmission (Block S154) of at least one second downlink signal to the wireless device, the at least one second downlink signal being received by the wireless device based on a quasi-colocation, QCL, parameter, the QCL parameter being associated with the CORESET pool index; and receive (Block S156) at least one uplink signal transmitted by the wireless device, the at least one uplink signal being transmitted by the wireless device based on a first spatial domain filter, the first spatial domain filter being associated with the CORESET pool index.

In some embodiments, the at least one second downlink signal is a physical downlink shared channel, PDSCH, and the causing transmission of the at least one second downlink signal is triggered by the first downlink signal. In some embodiments, the at least one first downlink signal is configured to cause the wireless device 22 to transmit the at least one uplink signal. In some embodiments, the at least one first downlink signal includes a downlink control information, DCI, message, and the DCI message includes a transmission configuration indicator, TCI, field that includes a TCI value indicating at least one indicated TCI state. In some embodiments, the QCL parameter is further based on the at least one indicated TCI state.

In some embodiments, the first spatial domain filter is further based on the at least one indicated TCI state. In some embodiments, the TCI value includes at least one TCI field codepoint, the at least one TCI field codepoint being associated with the at least one indicated TCI state. In some embodiments, the at least one TCI field codepoint is mapped to the at least one indicated TCI state based on a format of the at least one first downlink signal. In some embodiments, each of the at least one indicated TCI state indicates at least one of a joint TCI state, a downlink TCI state, and an uplink TCI state.

In some embodiments, the at least one second downlink signal is received by the wireless device based on a downlink beam, the downlink beam is determined based on a second spatial domain filter, and the second spatial domain filter is associated with the CORESET pool index. In some embodiments, at least one of the first spatial domain filter and the second spatial domain filter is updated based on the at least one indicated TCI state being different from a previously indicated TCI state. In some embodiments, both the first and second spatial domain filters are updated based on the at least one indicated TCI state indicating a joint TCI state.

In some embodiments, the second spatial domain filter is updated based on the at least one indicated TCI state indicating a downlink TCI state. In some embodiments, the first spatial domain filter is updated based on the at least one indicated TCI state indicating an uplink TCI state. In some embodiments, at least one acknowledgement/non-acknowledgement, ACK/NACK, signal associated with at least one physical downlink shared channel, PDSCH, scheduled by the DCI message is received, and the at least one indicated TCI state is updated based on a timing associated with the received at least one ACK/NACK signal. In some embodiments, the QCL parameter includes at least one of a delay spread parameter, a Doppler parameter, an average delay parameter, a Doppler shift parameter, and a spatial domain receive parameter. In some embodiments, each of the plurality of CORESETs is associated with a respective CORESET pool of a plurality of CORESET pools, and each of the plurality of CORESET pools is associated with a respective transmission and reception point, TRP.

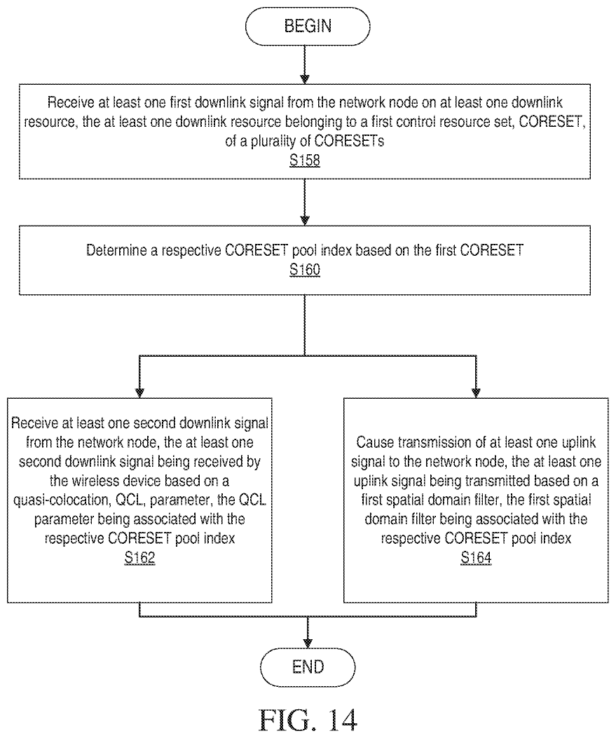

FIG. 14 is a flowchart of an example process in a wireless device 22 according to some embodiments of the present disclosure. One or more Blocks and/or functions and/or methods performed by wireless device 22 may be performed by one or more elements of wireless device 22 such as by QCL unit 34 in processing circuitry 84, processor 86, radio interface 82, etc. The wireless device 22 is configured to receive (Block S158) at least one first downlink signal from the network node 16 on at least one downlink resource, where the at least one downlink resource belongs to a first control resource set, CORESET, of a plurality of CORESETs. The wireless device 22 is further configured to determine (Block S160) a respective CORESET pool index based on the first CORESET. The wireless device 22 is further configured to at least one of: receive (Block S162) at least one second downlink signal from the network node 16, where the at least one second downlink signal is received by the wireless device based on a quasi-colocation, QCL, parameter, and the QCL parameter is associated with the respective CORESET pool index; and cause transmission of (Block S164) at least one uplink signal to the network node 16, where the at least one uplink signal is transmitted based on a first spatial domain filter, and the first spatial domain filter is associated with the respective CORESET pool index.

In some embodiments, the at least one second downlink signal is a physical downlink shared channel, PDSCH. In some embodiments, receiving the at least one first downlink signal triggers the wireless device to transmit the at least one uplink signal. In some embodiments, the at least one first downlink signal includes a downlink control information, DCI, message, and the DCI message includes a transmission configuration indicator, TCI, field that includes a TCI value indicating at least one indicated TCI state.

In some embodiments, the QCL parameter is further based on the at least one indicated TCI state. In some embodiments, the first spatial domain filter is further based on the at least one indicated TCI state. In some embodiments, the TCI value includes at least one TCI field codepoint, and the at least one TCI field codepoint is associated with the at least one indicated TCI state. In some embodiments, the at least one TCI field codepoint is mapped to the at least one indicated TCI state based on a format of the first downlink signal. In some embodiments, each of the at least one indicated TCI state indicates at least one of a joint TCI state, a downlink TCI state, and an uplink TCI state.

In some embodiments, receiving (Block S162) the at least one second downlink signal from the network node is based on a downlink beam, the downlink beam is determined based on a second spatial domain filter, and the second spatial domain filter is associated with the respective CORESET pool index. In some embodiments, at least one of the first spatial domain filter and the second spatial domain filter is updated based on the at least one indicated TCI state being different from a previously indicated TCI state. In some embodiments, both the first and second spatial domain filters are updated based on the at least one indicated TCI state indicating a joint TCI state. In some embodiments, the second spatial domain filter is updated based on the at least one indicated TCI state indicating a downlink TCI state.

In some embodiments, the first spatial domain filter is updated based on the at least one indicated TCI state indicating an uplink TCI state. In some embodiments, at least one acknowledgement/non-acknowledgement, ACK/NACK, signal associated with at least one physical downlink shared channel, PDSCH, scheduled by the DCI message is transmitted, and at least one indicated TCI state is updated based on a timing associated with the transmitted at least one ACK/NACK signal. In some embodiments, the QCL parameter includes at least one of a delay spread parameter, a Doppler parameter, an average delay parameter, a Doppler shift parameter, and a spatial domain receive parameter. In some embodiments, each of the plurality of CORESETs is associated with a respective CORESET pool of a plurality of CORESET pools, where each of the plurality of CORESET pools is associated with a respective transmission and reception point, TRP.

Having described the general process flow of arrangements of the disclosure and having provided examples of hardware and software arrangements for implementing the processes and functions of the disclosure, the sections below provide details and examples of arrangements for common spatial filter updates for multi-DCI based multi-TRP systems, which may be implemented by the network node 16, wireless device 22 and/or host computer 24.

One or more network node 16 functions described herein may be performed by one or more of configuration unit 32, processing circuitry 68, processor 70, etc. One or more wireless device 22 functions described herein may be performed by one or more of QCL unit 34, processing circuitry 84, processor 86, etc.

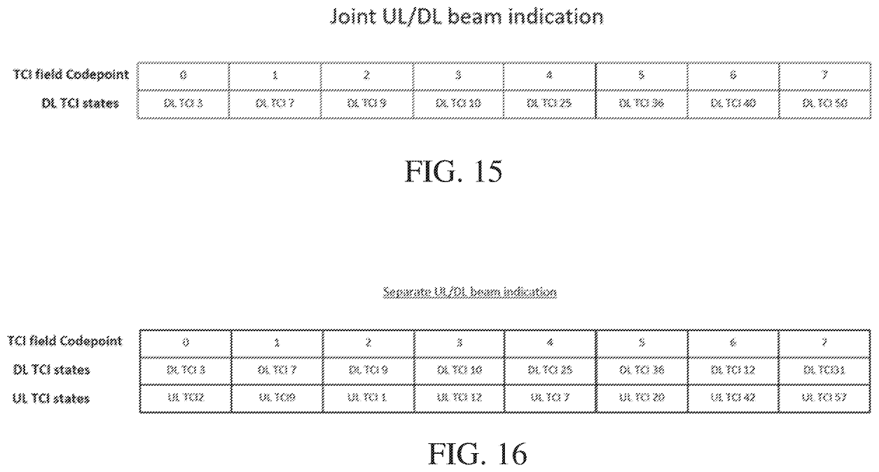

FIG. 15 illustrates an example of how a list of activated DL TCI states may be mapped to TCI field codepoints in DCI for Joint DL/UL TCI. In this case, a single TCI field codepoint in DCI is used to update a DL TCI state, which will be used to determine transmit/receive (TX/RX) spatial filter for both DL and UL signals/channels. For example, in case a DCI with TCI field codepoint 2 is indicated to the wireless device 22, the wireless device 22 should update its TX/RX spatial filter based on DL TCI state 9 for both DL and UL signals/channels.

FIG. 16 illustrates an example of how a list of activated DL/UL TCI states may be mapped to TCI field codepoints in DCI for Separate DL/UL TCI. Here each TCI field codepoint in DCI is associated with one DL TCI state and one UL TCI state. When a wireless device 22 is indicated with a certain TCI field codepoint, the wireless device 22 will apply the associated DL TCI state and UL TCI state.

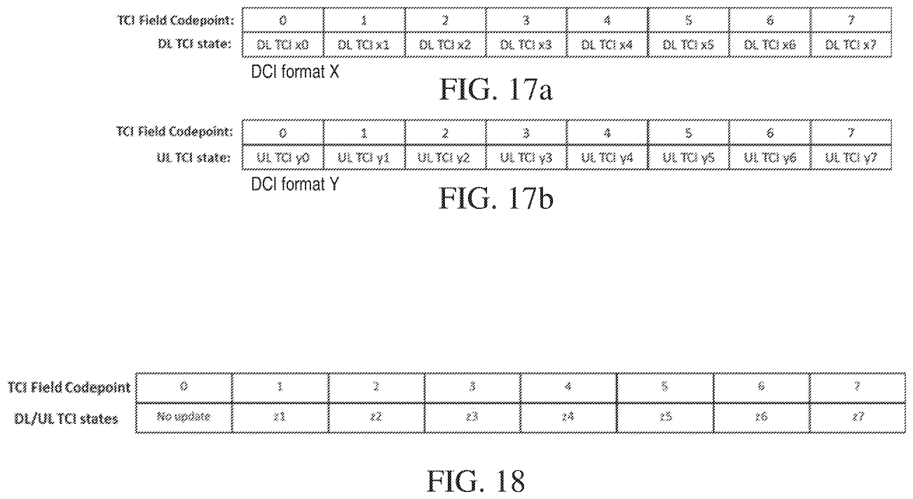

In another example shown in FIG. 17a and FIG. 17b, the DL and UL TCI states are mapped and/or activated separately to codepoints of TCI field in DCIs with different DCI formats. For example, DL TCI states may be activated and mapped to codepoints of TCI field in DCI format 1_1 and UL TCI states may be activated and mapped to codepoints of TCI field in DCI format 1_2.

In a further example shown in FIG. 18, one of the codepoints (e.g., codepoint 0) of the TCI field is not mapped to any TCI state and is used to indicate that there is no TCI state update.

It is noted that the term “TRP” may not be used in 3GPP technical specifications. In some embodiments, a TRP may be represented by one or more of: a network node 16, a radio head, a spatial relation, and/or a Transmission Configuration Indicator (TCI) state. A TRP may be represented by a CORESET Pool, CORESET Pool Index and/or a TCI state in some embodiments. In some embodiments, a TRP may be using multiple TCI states. In some embodiments, a TRP may be a part of the network node 16 (e.g., gNB) transmitting and receiving radio signals to/from wireless device 22 according to physical layer properties and parameters inherent to that element. In some embodiments, in Multiple Transmit/Receive Point (multi-TRP) operation, a serving cell can schedule the wireless device 22 from two TRPs (e.g., network nodes 16a and 16b), providing better PDSCH coverage, reliability and/or data rates.

There may be two different operational modes for multi-TRP: single-DCI and multi-DCI. For both modes, control of uplink and downlink operation may be performed by both the physical layer and MAC (e.g., which may be transmitted by the network node 16). In single-DCI mode, wireless device 22 is scheduled by the same DCI (e.g., transmitted by network node 16) for both TRPs and in multi-DCI mode, wireless device 22 is scheduled by independent DCIs from each TRP (e.g., network nodes 16a and 16b).

Some embodiments described in this disclosure may involve one or more of the following three embodiments, which may be implemented by network node 16 and/or wireless device 22:
the first embodiment covers how transmit/receive spatial filters are associated with CORESET pools (e.g., by wireless device 22 and network node 16) and details of which channels/signals the transmit/receive spatial filters specific to CORESET pools are applied (e.g., by wireless device 22 and network node 16).
the second embodiment covers details of how indication for update of transmit/receive spatial filters associated with CORESET pool(s) are received by the wireless device 22 (and/or transmitted by the network node 16).
the third embodiment covers update (e.g., at the wireless device 22) of transmit/receive spatial filters associated with CORESET pool(s).

These embodiments are described in more detail below.

### Embodiment 1: Association of Transmit/Receive Spatial Filters with CORESET Pools

In one embodiment, the wireless device 22 is configured with multiple control resource sets (CORESETs) where a subset of the CORESETs are associated with a first CORESET pool index and a second subset of the CORESETs are associated with a second CORESET pool index. In some embodiments, the two subsets of CORESETs are disjoint sets (i.e., a given CORESET can only be associated with one of the CORESET pools). FIG. 17a and FIG. 17b are diagrams of an example. Note that the CORESETs associated with one CORESET pool can belong to the same or different component carriers (or serving cells). As shown in the example, CORESETs 1-3 are associated with CORESET Pool Index 0, and CORESETs 4-5 are associated with CORESET Pool Index 1. A wireless device 22 maintains a receive spatial filter and/or a transmit spatial filter associated with each CORESET Pool Index. The receive spatial filter for a given CORESET Pool Index may be used to receive downlink channels and/or reference signals that are scheduled/triggered via a CORESET in the associated CORESET Pool Index. Similarly, the transmit spatial filter for that given CORESET Pool Index may be used to transmit uplink channels and/or reference signals that are scheduled/triggered via a CORESET in the associated CORESET Pool Index. The following are examples of how a transmit/receive spatial filter associated with a CORESET Pool Index may be used to transmit/receive different channels and reference signals:
Consider a PDCCH carrying a DCI in a CORESET associated with a CORESET Pool Index; this PDCCH is received by the wireless device 22 using the receive spatial filter associated with the CORESET Pool Index.
Consider a PDSCH that is scheduled via a DCI (i.e., a downlink grant with DCI formats 1_0, 1_1, or 1_2) carried by a PDCCH received in a CORESET; if this CORESET is associated with a CORESET Pool Index, then the PDSCH is received using the receive spatial filter associated with the CORESET Pool Index.
Consider an aperiodic CSI-RS that is triggered via a DCI (e.g., an uplink related DCI with DCI formats 0_0, 0_1 or 0_2) carried by a PDCCH received in a CORESET; if this CORESET is associated with a CORESET Pool Index, then the aperiodic CSI-RS is received using the receive spatial filter associated with the CORESET Pool Index.
Consider a PUSCH that is scheduled via a DCI (i.e., an uplink grant) carried by a PDCCH received in a CORESET; if this CORESET is associated with a CORESET Pool Index, then the PUSCH is transmitted using the transmit spatial filter associated with the CORESET Pool Index.
Consider a hybrid automatic repeat request (HARQ) ACK/NACK transmitted in a PUCCH in response to a PDSCH scheduled via a DCI (i.e., a downlink grant) carried by a PDCCH received in a CORESET associated with a CORESET Pool Index, then the PUCCH is transmitted using the transmit spatial filter associated with the CORESET Pool Index.
Consider an aperiodic sounding reference signal (SRS) that is triggered via a DCI (e.g., an uplink related DCI or downlink related DCI) carried by a PDCCH received in a CORESET; if this CORESET is associated with a CORESET Pool Index, then the aperiodic SRS is transmitted using the transmit spatial filter associated with the CORESET Pool Index.

In summary, in some embodiments, a DL channel or signal scheduled or triggered by a DCI carried by a PDCCH in a CORESET with a CORESET pool index is received by the wireless device 22 with a spatial filer associated with the CORESET pool index. Similarly, an UL channel or signal scheduled or triggered by a DCI, or is associated with a DL channel scheduled by a DCI, carried by a PDCCH in a CORESET with a CORESET pool index is transmitted by the wireless device 22 with a spatial filer associated with the CORESET pool index.

Note that in NR, in some embodiments, a PUCCH resource may not be directly associated with a CORESET Pool index (for example, a PUCCH resource that is configured to carry periodic CSI report feedback). In this case, in one embodiment, such PUCCH resources can be explicitly associated with a CORESET pool index via higher layer configuration (e.g., via RRC configuration of the CORESET pool index in the PUCCH resource configuration). Alternatively, or additionally, in some embodiments, PUCCH resources may be grouped into a group of PUCCH resources and each group of PUCCH resources may be associated with a CORESET pool index, either semi-statically configured by RRC, or dynamically updated by a MAC CE (sent to wireless device 22 by NN 16 (i.e., network node 16)). After associating the PUCCH resource(s) with a CORESET Pool Index, the PUCCH resource(s) are transmitted (e.g., by wireless device 22) using the transmit spatial filter associated with the CORESET Pool Index.

Similarly, in some embodiments, a SRS resource may not be directly associated with a CORESET Pool index (for example, a periodic SRS that is to be transmitted periodically). In this case, in one embodiment, such SRS resources can be explicitly associated with a CORESET pool index via higher layer configuration (e.g., via RRC configuration of the CORESET pool index in the SRS resource/SRS resource set configuration). Alternatively, SRS resources may be grouped into a group of SRS resources (or group of SRS resource sets) and each group of SRS resources (or SRS resource sets) may be associated with a CORESET pool index, either semi-statically configured by RRC or dynamically updated by a MAC CE. After associating the SRS resource(s) with a CORESET Pool Index, the SRS resource(s) are transmitted (e.g., by wireless device 22) using the transmit spatial filter associated with the CORESET Pool Index.

In addition, a CSI-RS resource may not be directly associated with a CORESET Pool index (for example, a periodic CSI-RS that is to be transmitted periodically). In this case, in one embodiment, such CSI-RS resources can be explicitly associated with a CORESET pool index via higher layer configuration (e.g., via RRC configuration of the CORESET pool index in the CSI-RS resource/CSI-RS resource set configuration). Alternatively, or additionally, in some embodiments, CSI-RS resources may be grouped into a group of CSI-RS resources (or group of CSI-RS resource sets) and each group of CSI-RS resources (or group of CSI-RS resource sets) may be associated with a CORESET pool index, either semi-statically configured by RRC or dynamically updated by a MAC CE (sent to wireless device 22 by NN 16). After associating the CSI-RS resource(s) with a CORESET Pool Index, the CSI-RS resource(s) are received (e.g., by wireless device 22) using the receive spatial filter associated with the CORESET Pool Index.

In one variant of this embodiment, a joint TCI state is activated per each CORESET pool index. In some embodiments, the joint TCI state provides the source reference signal (e.g., QCL Type-D reference signal source) which may be used to update both the receive spatial filter and the transmit spatial filter associated with the CORESET pool index. If the source reference signal is a downlink reference signal, both the receive and transmit filters associated with the CORESET pool index may be updated to the receive filter used to receive the source reference signal. If the source reference signal is an uplink reference signal, both the receive and transmit filters may be updated to the transmit filter used to transmit the source reference signal.

In another variant of this embodiment, a DL TCI state is activated (e.g., MAC CE) per each CORESET pool index. In some embodiments, the DL TCI state provides the source reference signal (e.g., QCL Type-D reference signal source) which may be used to update the receive spatial filter corresponding to the CORESET pool index. If the source reference signal is a downlink reference signal, the receive filter associated with the CORESET pool index may be updated to the receive filter used to receive the source reference signal. If the source reference signal is an uplink reference signal, the receive filter may be updated to the transmit filter used to transmit the source reference signal.

In yet another variant of this embodiment, an UL TCI state is activated (e.g., MAC CE) per each CORESET pool index. In some embodiments, the UL TCI state provides the source reference signal (e.g., QCL Type-D reference signal source) which is used to update the transmit spatial filter corresponding to the CORESET pool index. If the source reference signal is a downlink reference signal, the transmit filter associated with the CORESET pool index may be updated to the receive filter used to receive the source reference signal. If the source reference signal is an uplink reference signal, the transmit filter may be updated to the transmit filter used to transmit the source reference signal.

In some cases, each CORESET pool index may be activated with only a joint TCI state. In some other cases, each CORESET pool index is activated with either DL TCI state or UL TCI state. In some further cases, each CORESET pool index is activated with both a DL TCI state and a UL TCI state.

A benefit of this embodiment may be that that embodiment allows a common beam to be applied to each CORESET pool such that there can be one common beam per TRP (where TRP is represented by a CORESET Pool index). The common beam here refers to the receive spatial filter and/or transmit spatial filter maintained per CORESET pool index.

Note that the joint TCI state currently active for a given CORESET Pool Index at the wireless device 22 is the joint TCI state corresponding to the receive/transmit spatial filters currently used for the given CORESET Pool Index. The DL TCI state currently active for a given CORESET Pool Index at the wireless device 22 is the DL TCI state corresponding to the receive spatial filters currently used for the given CORESET Pool Index. The UL TCI state currently active for a given CORESET Pool Index at the wireless device 22 is the UL TCI state corresponding to the transmit spatial filters currently used for the given CORESET Pool Index.

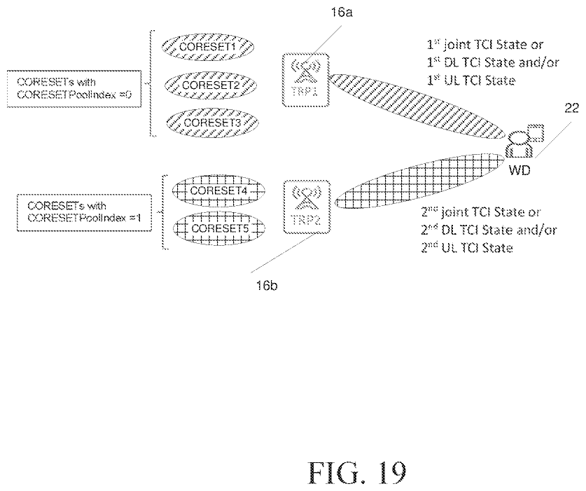

FIG. 19 is a diagram of an example showing a wireless device 22 configured with two subsets of CORESETs with each subset of CORESETs associated with a corresponding CORESETPoolIndex and a common beam.

Although some embodiments in this disclosure cover the cases where one transmit spatial filter and one receive spatial filter are maintained per CORESET Pool Index, the embodiments may be extended to the case where more than one transmit spatial filter and more than one receive spatial filter are maintained per CORESET Pool Index. In one example, in one CORESET Pool, one transmit/receive spatial filter may be used for control channels (i.e., PUCCH/PDCCH) that use a rather wide beam, and another transmit/receive spatial filter may be used for data channels (i.e., PUSCH/PDSCH).

In one embodiment, instead of explicitly configuring a CORESET pool index in the RRC configuration of each signal/channel (for example by configuring a CORESET pool index in a periodic SRS resource set), a new information element (IE) may be defined in e.g., 3GPP TS 38.311 where signals/channels that should apply to the new unified TCI state framework are listed and their association to the different CORESET pool indexes are explicitly configured. One schematic example of this can be seen in the IE below. In this case two new fields are introduced, “CORESETPoolIndex0” and “CORESETPoolIndex1”, and different SRS resource sets/CSI-RS resource sets and/or PUCCH resource sets are listed under one of these two fields depending on which CORESET pool index it should be associated with. Note that this is just one illustrative example, and where and how the explicit configuration with associations between DL/UL signals/channels and the CORESET pool indexes are configured may vary.

### Example Unified TCI State Framework Information Element (IE)

-- ANI1START

| | |
|---|---|
| CORESETPoolIndex0 ::= | SEQUENCE { |
| nzp=CSI-RS-ResourceSetList | SEQUENCE (SIZE (1 . . . maxNrofNZP-CSI-RS- |

ResourceSets)) OF NZP-CSI-RS-ResourceSetId

| | |
|---|---|
| srs-ResourceSetIdList | SEQUENCE (SIZE (1 . . . maxNrofSRS- |

ResourcesSets)) OF SRS-ResourceSetId

| | |
|---|---|
| Pucch-ResourceSetList | SEQUENCE {SIZE (1 . . . maxNrofPUCCH- |

ResourcesSets)) OF PUCCH-ResourceSetId
}

| | |
|---|---|
| CORESETPoolIndex1 ::= | SEQUENCE { |
| nzp=CSI-RS-ResourceSetList | SEQUENCE (SIZE (1 . . . maxNrofNZP-CSI-RS- |

ResourceSets)) OF NZP-CSI-RS-ResourceSetId

| | |
|---|---|
| srs-ResourceSetIdList | SEQUENCE (SIZE (1 . . . maxNrofSRS- |

ResourcesSets)) OF SRS-ResourceSetId

| | |
|---|---|
| Pucch-ResourceSetList | SEQUENCE {SIZE (1 . . . maxNrofPUCCH- |

ResourcesSets)) OF PUCCH-ResourceSetId
}
-- ANI1STOP

The above example IE is an example of an RRC configured list of DL/UL signals/channels that may be using the new unified TCI framework, and their association to a particular CORESET pool index.

In one embodiment, in case a semi-persistent DL channel/signal is activated by a MAC-CE, and where the MAC-CE is received by the wireless device 22 through a PDSCH that is scheduled via a DCI (i.e., a downlink grant) carried by a PDCCH received in a CORESET; if this CORESET is associated with a CORESET Pool Index, then the semi-persistent DL signal/channel may be received (e.g., by wireless device 22) with a receive spatial filter associated with that CORESET pool index.

In one embodiment, in case a semi-persistent UL channel/signal is activated by a MAC-CE, and where the MAC-CE is received by the wireless device 22 through a PDSCH that is scheduled via a DCI (i.e., a downlink grant) carried by a PDCCH received in a CORESET; if this CORESET is associated with a CORESET Pool Index, then the semi-persistent UL signal/channel may be transmitted (e.g., by wireless device 22) with a transmit spatial filter associated with that CORESET pool index.

In one embodiment, when a semi-persistent DL signal/channel is activated with a MAC-CE, that MAC-CE explicitly indicates a CORESET pool index, and then the semi-persistent DL signal/channel may be received (e.g., by wireless device 22) with a receive spatial filter associated with that explicitly indicated CORESET pool index.

In one embodiment, when a semi-persistent UL signal/channel is activated with a MAC-CE, that MAC-CE explicitly indicates a CORESET pool index, and then the semi-persistent UL signal/channel may be transmitted (e.g., by wireless device 22) with a transmit spatial filter associated with that explicitly indicated CORESET pool index.

### Embodiment 2: Indication for Update of Transmit/Receive Spatial Filters Associated with CORESET Pool(s)

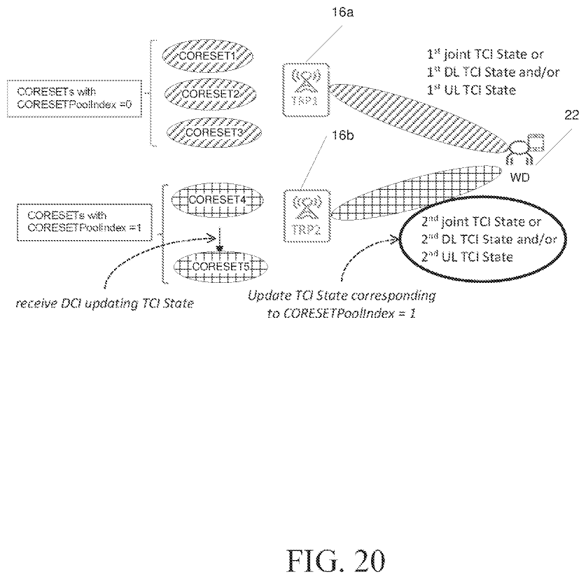

In this embodiment, when a wireless device 22 receives a DCI that indicates a joint TCI State via a PDCCH in a CORESET associated with a CORESET Pool index, then the wireless device 22 receives the indication to update the joint TCI state associated with that CORESET Pool Index. The joint TCI State is indicated in a codepoint of the TCI field of the DCI. Reception of the DCI that indicates a joint TCI state is an indication for the wireless device 22 to update both the receive spatial filter and the transmit spatial filter associated with the CORESET Pool Index. FIG. 20 is a diagram of an example where the wireless device 22 receives a DCI for updating a joint TCI State in a PDCCH in CORESET 5 which is associated with CORESET Pool Index 1. The reception of this DCI means that the wireless device 22 would update both the receive spatial filter and the transmit spatial filter associated with CORESET Pool Index 1. Note that the updated receive spatial filter may be used to receive downlink channels and/or reference signals that are scheduled/triggered via a CORESET in CORESET Pool Index 1. Similarly, the updated transmit spatial filter will be used to transmit uplink channels and/or reference signals scheduled/triggered via a CORSET in CORESET Pool Index 1.

Note that in some embodiments, the wireless device 22 may only update the receive spatial filter and/or the transmit spatial filter if the indicated joint TCI State is different from the already active joint TCI State (i.e., the joint TCI State corresponding to the receive/transmit spatial filters currently used for the CORESET Pool Index). In some other embodiments, the wireless device 22 would only update the receive spatial filter and/or the transmit spatial filter if the source reference signal(s) in the indicated joint TCI State is different from the source reference signal(s) in the already active joint TCI State in the corresponding CORESET Pool.

In another variant of this embodiment, when a wireless device 22 receives a DCI that indicates a DL TCI State via a PDCCH in a CORESET associated with a CORESET Pool index, then the wireless device 22 receives the indication to update the DL TCI state associated with that CORESET Pool Index. The joint TCI State is indicated in a codepoint of the TCI field of the DCI. Reception of the DCI that indicates a DL TCI state is an indication for the wireless device 22 to update the receive spatial filter associated with the CORESET Pool Index. In the example of FIG. 20, the wireless device 22 receives a DCI for updating a DL TCI State in a PDCCH in CORESET 5 which is associated with CORESET Pool Index 1. The reception of this DCI means that the wireless device 22 would update the receive spatial filter associated with CORESET Pool Index 1. Note that the updated receive spatial filter will be used to receive downlink channels and/or reference signals that are scheduled/triggered via a CORESET in CORESET Pool Index 1.

Note that in some embodiments, the wireless device 22 would only update the receive spatial filter if the indicated DL TCI State is different from the already active DL TCI State (i.e., the DL TCI State corresponding to the receive spatial filter currently used for the CORESET Pool Index). In some other embodiments, the wireless device 22 would only update the receive spatial filter if the source reference signal in the indicated DL TCI State is different from the source reference signal in the already active DL TCI State in the corresponding CORESET Pool.

In yet another variant of this embodiment, when a wireless device 22 receives a DCI that indicates an UL TCI State via a PDCCH in a CORESET associated with a CORESET Pool index, then the wireless device 22 receives the indication to update the UL TCI state associated with that CORESET Pool Index. The UL TCI State is indicated in a codepoint of the TCI field of the DCI. Reception of the DCI that indicates an UL TCI state is an indication for the wireless device 22 to update the transmit spatial filter associated with the CORESET Pool Index. In the example of FIG. 20, the wireless device 22 receives a DCI for updating an UL TCI State in a PDCCH in CORESET 5 which is associated with CORESET Pool Index 1. The reception of this DCI means that the wireless device 22 would update the transmit spatial filter associated with CORESET Pool Index 1. Note that the updated transmit spatial filter will be used to receive uplink channels and/or reference signals that are scheduled/triggered via a CORESET in CORESET Pool Index 1.

Note that in some embodiments, the wireless device 22 would only update the transmit spatial filter if the indicated UL TCI State is different from the already active UL TCI State (i.e., the UL TCI State corresponding to the receive/transmit spatial filters currently used for the CORESET Pool Index). In some other embodiments, the wireless device 22 would only update the transmit spatial filter if the source reference signal(s) in the indicated UL TCI State is different from the source reference signal in the already active UL TCI State in the corresponding CORESET Pool.

Some benefits of the embodiment may include: with the solutions in this embodiment, wireless device 22 knows which CORESET Pool's TCI state is to be updated upon receiving the DCI indicating TCI state update. If the DCI is received in a CORESET associated with the CORESET Pool, then it is the TCI states (i.e., transmit/receive spatial filters) corresponding to that CORESET Pool that gets updated. Furthermore, this embodiment may provide an efficient TCI state update mechanism since transmit/receive filters for transmitting/receiving all channels/signals associated with the CORESET Pool index get updated via single DCI. This may also save signaling overhead for beam update in the multi-DCI based multi-TRP deployment.

For cases when N>1 receive spatial filters and M>1 transmit spatial filters are maintained per CORESET Pool index, a codepoint in the TCI field of DCI may provide N different DL TCI states and M different UL TCI states. Then, the N DL TCI states indicated are used to update the N receive spatial filters for each CORESET Pool index. Similarly, the M transmit spatial filters are updated using the M UL TCI states indicated.

### Embodiment 3: Update of Transmit/Receive Spatial Filters Associated with CORESET Pool(s)

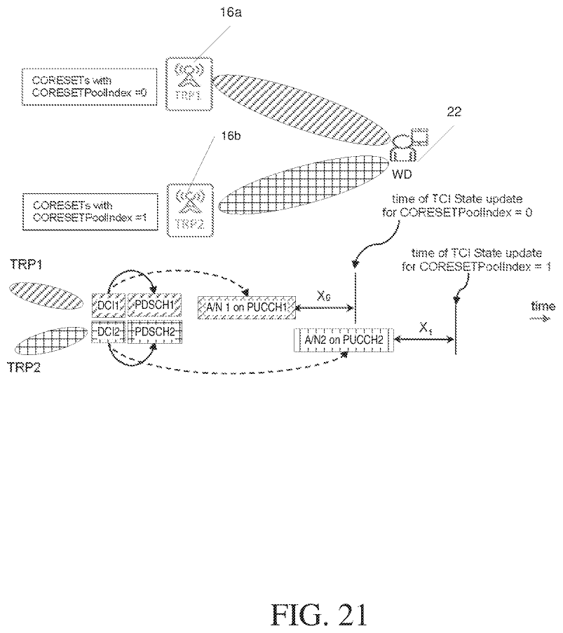

In this embodiment, the DCI that indicates TCI state update also schedules a PDSCH data (e.g., with DCI format 1_1 or 1_2). Hence, the ACK/NACK (A/N) corresponding to the PDSCH can be used as a reference point to determine when the indicated TCI state is updated by the wireless device 22 (i.e., when the transmit/receive spatial filters are updated by the wireless device 22 upon receiving the DCI). FIG. 21 is a diagram of an example where the A/N corresponding to the two PDSCHs scheduled are transmitted on separate PUCCH resources.
DCI1 (e.g., DCI format 1_1 or 1_2) is carried by a PDCCH received over a CORESET in CORESET Pool 0 (i.e., CORESET Pool with index 0). The ACK/NACK (shown as A/N1 in the figure) for PDSCH1 that is scheduled by DCI1 is sent over PUCCH resource PUCCH1, and the TCI State update for CORESET Pool 0 is performed by the wireless device 22 after a time X₀ from the last symbol of PUCCH1. Note that in this case, PUCCH1 is transmitted using the uplink spatial filter that is used for CORESET Pool 0 before the TCI state update happens.
DCI2 (e.g., DCI format 1_1 or 1_2) is carried by a PDCCH received over a CORESET in CORESET Pool 1 (i.e., CORESET Pool with index 1). The ACK/NACK (shown as A/N2 in the figure) for PDSCH2 that is scheduled by DCI2 is sent over PUCCH resource PUCCH2, and the TCI State update for CORESET Pool 1 is performed by the wireless device 22 after a time X₁ from the last symbol of PUCCH2. Note that in this case, PUCCH2 is transmitted using the uplink spatial filter that is used for CORESET Pool 1 before the TCI state update happens.

In some embodiments, the time gaps X₀ and X₁ may be the same, and in some further embodiments, these time gaps may depend on wireless device 22 capability. For instance, a wireless device 22 may report to the network (e.g., NN 16) on the time gap it needs before it can update the TCI states (i.e., update receive/transmit spatial filters) after the transmission of the ACK/NACK on PUCCH. The network (e.g., NN 16) then configures a value of the time gap (e.g., via RRC signaling) that the wireless device 22 may use when updating the TCI states. In an alternative embodiment, the wireless device 22 may only switch the TCI state when an ACK is fed back in the respective PUCCH (e.g., TCI state for CORESET Pool 0 is only updated if an ACK is sent on PUCCH1, and TCI state for CORESET Pool 1 is only updated if an ACK is sent on PUCCH2). The benefit of this embodiment may be that the TCI states for each TRP (i.e., each CORESET Pool) can be independently updated which is useful in case only the TCI state of only one of the TRPs needs to be updated.

In an alternative embodiment, the DCI that indicates TCI state update also schedules a PDSCH data. Hence, the ACK/NACK (A/N) corresponding to the PDSCH can be used as a reference point to determine when the indicated TCI state is updated by the wireless device 22 (i.e., when the transmit/receive spatial filters are updated by the wireless device 22 upon receiving the DCI). However, what is different from the example in 19 is that the A/N bits corresponding to both PDSCHs scheduled via DCIs received in CORESETs in the two CORESET Pools are transmitted in a single PUCCH resource (sometimes referred to as joint A/N feedback, which can be configured for a wireless device 22 when two TRPs (e.g., NN 16a and NN 16b) share a same scheduler or there is an ideal backhaul with negligible latency connecting the two TRPs (e.g., NN16a and NN 16b), in which case, the A/N can be feedback to any one of the two TRPs).

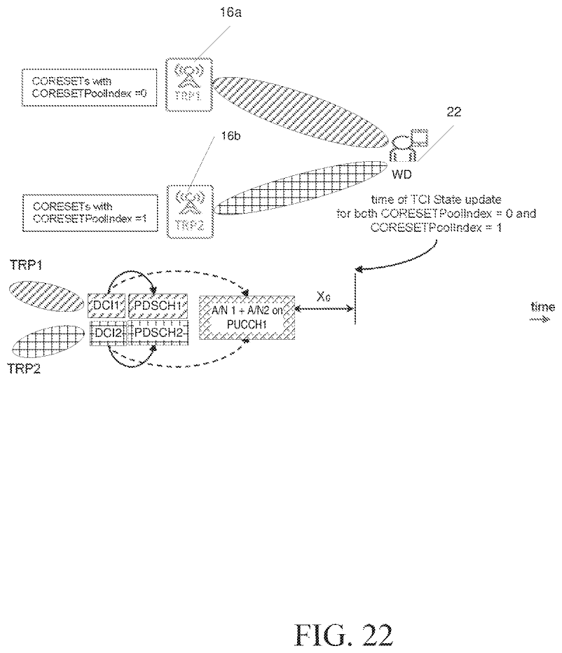

FIG. 22 is a diagram of an example where the A/N corresponding to the two PDSCHs scheduled are transmitted on the same PUCCH resource.
DCI1 is carried by a PDCCH received over a CORESET in CORESET Pool 0 (i.e., CORESET Pool with index 0). The ACK/NACK (shown as A/N1 in the figure) for PDSCH1 that is scheduled by DCI1 is sent over PUCCH resource PUCCH1, and the TCI State update for CORESET Pool 0 is performed by the wireless device 22 after a time X₀ from the last symbol of PUCCH1.
DCI2 is carried by a PDCCH received over a CORESET in CORESET Pool 1 (i.e., CORESET Pool with index 1). The ACK/NACK (shown as A/N2 in the figure) for PDSCH2 that is scheduled by DCI2 is also sent over PUCCH resource PUCCH1, and the TCI State update for CORESET Pool 1 is performed by the wireless device 22 after a time X₀ from the last symbol of PUCCH1.

Note that in this case, PUCCH1 is transmitted by wireless device 22 using the uplink spatial filter that is used for either CORESET Pool 0 or COREST Pool 1 before the TCI state update happens (e.g., PUCCH1 may be associated with a last DCI among DCI1 and DCI2 received by the wireless device 22 and the spatial filter used is associated with the CORESET pool in which the last DCI is received). A benefit of this embodiment may be that the TCI states of both TRPs (e.g., NN 16a and NN 16b) (i.e., both CORESET Pools) can be updated at the same time. This may be useful in case when the wireless device 22 is moving at high speed where the TCI state corresponding to both CORESET Pools need to be updated quickly.

In another alternative embodiment, the last symbol of the DCI that indicates TCI state update is used as a reference point to determine when the indicated TCI state is updated by the wireless device 22 (i.e., when the transmit/receive spatial filters are updated by the wireless device 22 upon receiving the DCI).

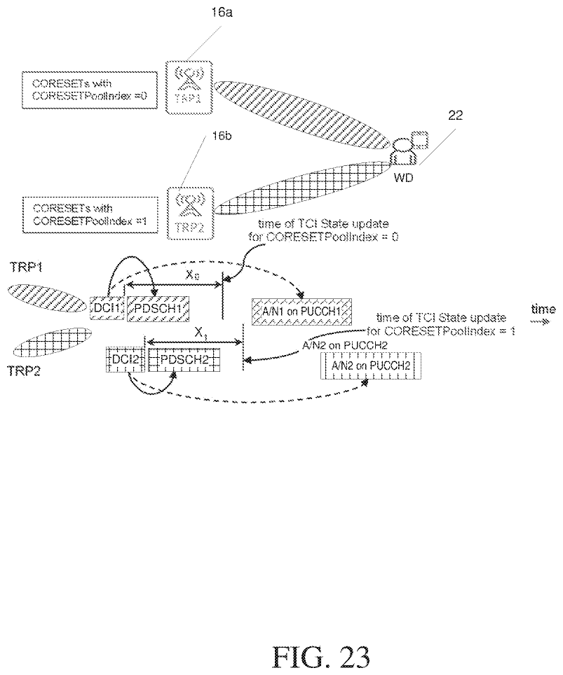

FIG. 23 is a diagram of an example where the A/N corresponding to the two PDSCHs scheduled are transmitted on separate PUCCH resources.

DCI1 is carried by a PDCCH received over a CORESET in CORESET Pool 0 (i.e., CORESET Pool with index 0). The ACK/NACK (shown as A/N1 in the figure) for PDSCH1 that is scheduled by DCI1 is sent over PUCCH resource PUCCH1, and the TCI State update for CORESET Pool 0 is performed by the wireless device 22 after a time X₀ from the last symbol of the PDCCH that carries DCI1. Note that in this case, since the time X₀ from the last symbol of PDCCH that carries DCI1 happens before PUCCH1 starts, PUCCH1 is transmitted by wireless device 22 using the updated uplink spatial filter that is used for CORESET Pool 0.

DCI2 is carried by a PDCCH received over a CORESET in CORESET Pool 1 (i.e., CORESET Pool with index 1). The ACK/NACK (shown as A/N2 in the figure) for PDSCH2 that is scheduled by DCI2 is sent over PUCCH resource PUCCH2, and the TCI State update for CORESET Pool 1 is performed by the wireless device 22 after a time X₁ from the last symbol of the PDCCH that carries DCI2. Note that in this case, since the time X1 from the last symbol of PDCCH that carries DCI2 happens before PUCCH2 starts, PUCCH2 is transmitted by wireless device 22 using the updated uplink spatial filter that is used for CORESET Pool 1.

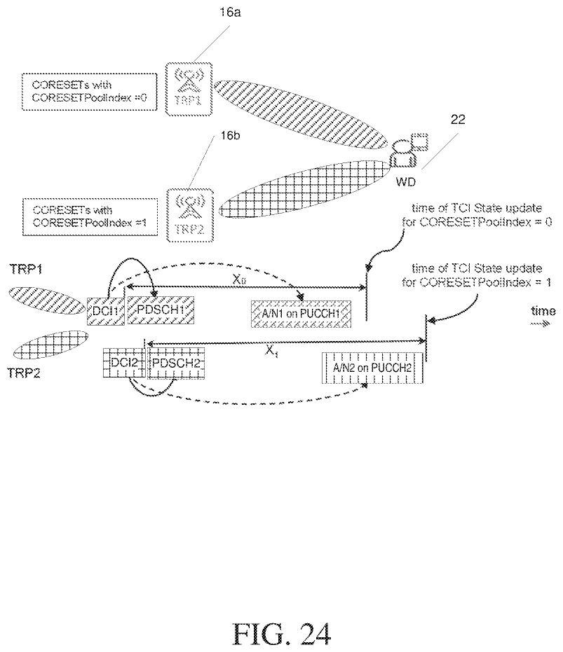

FIG. 24 is a diagram of another example where the A/N corresponding to the two PDSCHs scheduled are transmitted on separate PUCCH resources.

DCI1 is carried by a PDCCH received over a CORESET in CORESET Pool 0 (i.e., CORESET Pool with index 0). The ACK/NACK (shown as A/N1 in the figure) for PDSCH1 that is scheduled by DCI1 is sent over PUCCH resource PUCCH1, and the TCI State update for CORESET Pool 0 is performed by the wireless device 22 after a time X₀ from the last symbol of the PDCCH that carries DCI1. Note that in this case, since the time X₀ from the last symbol of PDCCH that carries DCI1 happens after PUCCH1 starts, PUCCH1 is transmitted by wireless device 22 using the uplink spatial filter that is used for CORESET Pool 0 before the TCI state update happens.

DCI2 is carried by a PDCCH received over a CORESET in CORESET Pool 1 (i.e., CORESET Pool with index 1). The ACK/NACK (shown as A/N2 in the figure) for PDSCH2 that is scheduled by DCI2 is sent over PUCCH resource PUCCH2, and the TCI State update for CORESET Pool 1 is performed by the wireless device 22 after a time X₁ from the last symbol of the PDCCH that carries DCI2. Note that in this case, since the time X₁ from the last symbol of PDCCH that carries DCI2 happens after PUCCH2 starts, PUCCH2 is transmitted by wireless device 22 using the uplink spatial filter that is used for CORESET Pool 1 before the TCI state update happens.

### SOME EXAMPLES

Example A1. A network node 16 configured to communicate with a wireless device 22, the network node 16 configured to, and/or comprising a radio interface and/or comprising processing circuitry configured to:
transmit information associating at least one first reference signal and/or at one first channel to at least a first subset of control resource sets (CORESETs);
transmit information associating at least one second reference signal and/or at least one second channel to at least a second subset of CORESETs;
transmit a downlink control information (DCI) on a physical downlink control channel (PDCCH) in a CORESET to the wireless device 22; and
transmit to and/or receive signaling from the wireless device 22, the signaling being transmitted/received based at least in part on quasi-colocation (QCL) information, the QCL information being based at least in part on which one of the first and second subset of CORESETs that the CORESET the DCI is transmitted on belongs to.

Example A2. The network node 16 of Example A1, wherein the DCI comprises a transmission configuration indicator (TCI) field comprising a value indicating at least one TCI state, the QCL information being determined from and/or based at least in part on the indicated at least one TCI state.

Example A3. The network node 16 of any one of Examples A1 and A2, wherein the signaling is transmitted/received based at least in part on a spatial domain filter, the spatial domain filter being based at least in part on which one of the first and second subset of CORESETs that the CORESET the DCI is transmitted on belongs to; and/or
wherein the signaling is a beam transmitted/received based at least in part on the spatial domain filter associated with the one the first and second subset of CORESETs that the CORESET the DCI is transmitted on belongs to; and/or
wherein the spatial domain filter comprises at least one of a spatial domain transmit filter and a spatial domain receive filter.

Example A4. The network node 16 of any one of Examples A1-A3, wherein the signaling transmitted to the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI; and/or
wherein the signaling received from the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

Example A5. The network node 16 of any one of Examples A1-A4, wherein the transmitted signaling comprises at least one of a physical downlink shared channel (PDSCH), a reference signal (RS) and a CSI-RS; and/or
wherein the received signaling comprises at least one of an acknowledgement/non-acknowledgement (ACK/NACK), a sounding reference signal (SRS) and a physical uplink shared channel (PUSCH).

Example A6. The network node 16 of any one of Examples A2-A5, wherein which one or more of the at least one first and second reference signals and/or the at least one first and second channels that the indicated at least one TCI state applies to/is updated by is based at least in part on a type of the at least one TCI state.

Example A7. The network node 16 of Example A6, wherein the type of the at least one TCI state comprises at least one of a joint TCI state, a downlink (DL) TCI state and an uplink (UL) TCI state.

Example A8. The network node 16 of any one of Examples A3-A7, wherein if the type of an indicated TCI state comprises the joint TCI state, the indicated TCI state applies to/updates both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example A9. The network node 16 of any one of Examples A3-A7, if the type of an indicated TCI state is the DL TCI state, the indicated TCI state applies to/updates the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example A10. The network node 16 of any one of Examples A3-A7, if the type of an indicated TCI state is the UL TCI state, the indicated TCI state applies to/updates the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example A11. The network node 16 of any one of Examples A2-A10, wherein spatial domain filters are updated only if the indicated TCI state is different from an active TCI state that is associated with the one of the first and second subset of CORESETs that the CORESET the DCI is transmitted on belongs to.

Example A12. The network node 16 of any one of Examples A2-A11, wherein the value comprised in the TCI field in the DCI is a TCI field codepoint out of a plurality of TCI field codepoints, the TCI field codepoint indicating the at least one TCI state out of a plurality of TCI states configured to the wireless device 22; and/or wherein the value comprised in the DCI is one of a joint UL/DL TCI state beam indication, a downlink (DL) TCI state beam indication and an uplink (UL) TCI state beam indication.

Example A13. The network node 16 of Example A12, wherein one of the plurality of TCI field codepoints configured to the wireless device 22 indicates that there is no TCI state update.

Example A14. The network node 16 of any one of Examples A2-A13, wherein the at least one TCI state that is indicated by the TCI field codepoint is based at least in part on a DCI format of the DCI transmitted on the PDCCH.

Example A15. The network node 16 of any one of Examples A2-A14, wherein if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

Example A16. The network node 16 of any one of Examples A1-A15, wherein the network node 16 (NN) and/or the radio interface and/or the processing circuitry is configured to cause the NN to:

transmit configuration information to the wireless device 22, the configuration information configuring the wireless device 22 with a plurality of CORESETs, the first subset of CORESETs being associated with a first CORESET pool index value and the second subset of CORESETs being associated with a second CORESET pool index value.

Example A17. The network node 16 of Example A16, wherein the first and second subsets are disjoint sets.

Example A18. The network node 16 of any one of Examples A1-A17, wherein, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index.

Example A19. The network node 16 of any one of Examples A1-A18, wherein the association of the at least one first reference signal and/or the at one first channel to the first subset of CORESETs and the association of the at least one second reference signal and/or the at one second channel to the second subset of CORESETs is via a radio resource control (RRC) configuration.

Example A20. The network node 16 of Example A19, wherein the RRC configuration comprises a channel/signal resource configuration comprising an index value identifying the one of the first and second subsets of CORESETs to be associated with the channel/signal resource.

Example A21. The network node 16 of any one of Examples A1-A20, wherein the association of the at least one first reference signal and/or the at one first channel to the first subset of CORESETs and the association of the at least one second reference signal and/or the at one second channel to the second subset of CORESETs is via a medium access control (MAC) control element (CE).

Example A22. The network node 16 of Example A21, wherein the MAC CE indicates a channel/signal resource associated with one of the first and second subsets of CORESETs to be associated with the channel/signal resource; and/or wherein the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources.

Example A23. The network node 16 of Example A19, wherein the RRC configuration information comprises a plurality of CORESET pool index values, each index value identifying a corresponding subset of CORESETs and indicating at least one reference signal/channel associated with the respective index value.

Example A24. The network node 16 of any one of Examples A1-A23, wherein the network node 16 (NN) and/or the radio interface and/or the processing circuitry is configured to cause the NN to:
activate TCI states in a MAC CE, the activated TCI states being mapped to TCI field codepoints; and
wherein the activated TCI states comprising one of a joint TCI state, a DL TCI state and an UL TCI state.

Example A25. The network node 16 of Example A24, wherein the one of the joint TCI state, the DL TCI state and the UL TCI state is activated per corresponding CORESET subset and/or per corresponding CORESET pool index value.

Example A26. The network node 16 of any one of Examples A1-A25, wherein the network node 16 (NN) and/or the radio interface and/or the processing circuitry is configured to cause the NN to:
receive at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one received ACK/NACK.

Example A27. The network node 16 of Example A26, wherein the network node 16 (NN) and/or the radio interface and/or the processing circuitry is configured to cause the NN to: receive separate acknowledgements/non-acknowledgements (ACK/NACKs) for physical downlink shared channels (PDSCHs) scheduled by the DCI and/or another DCI.

Example A28. The network node 16 of Example A26, wherein the network node 16 (NN) and/or the radio interface and/or the processing circuitry is configured to cause the NN to: receive joint acknowledgements/non-acknowledgements (ACK/NACKs) for physical downlink shared channels (PDSCHs) scheduled by the DCI and/or another DCI.

Example A29. The network node 16 of any one of Examples A1-A27, wherein the QCL information and/or spatial domain filters associated with the corresponding subset of CORESETs are independently updated at the wireless device 22 at different times.

Example A30. The network node 16 of Example A26-A29, wherein the time of the update is associated with the corresponding subset of CORESETs and/or the corresponding index value identifying the subset.

Example A31. The network node 16 of any one of Examples A1-A28, wherein the QCL information and/or spatial domain filters associated with the corresponding subset of CORESETs are jointly updated at the wireless device 22 at a same time.

Example A32. The network node 16 of any one of Examples A1-A31,
wherein the at least one first and second reference signals and/or the at least one first and second channels associated with the first and second subsets of CORESETs configured to the wireless device 22 are also associated with different cell identifiers (IDs);
wherein the different cell IDs are associated with multiple transmit receive points (TRPs), the multiple TRPs being associated with one or more network nodes 16 in communication with the wireless device 22;
wherein the QCL information is indicated via a transmission configuration indicator (TCI) state; and/or
wherein the QCL information comprises at least one of a delay spread parameter, a Doppler parameter, an average delay parameter, a Doppler shift parameter, a spatial domain receive parameter and a spatial domain transmit parameter.

Example B1. A method implemented in a network node 16, the method comprising:
transmitting information associating at least one first reference signal and/or at one first channel to at least a first subset of control resource sets (CORESETs);
transmitting information associating at least one second reference signal and/or at least one second channel to at least a second subset of CORESETs;
transmitting a downlink control information (DCI) on a physical downlink control channel (PDCCH) in a CORESET to the wireless device 22; and
transmitting to and/or receiving signaling from the wireless device 22, the signaling being transmitted/received based at least in part on quasi-colocation (QCL) information, the QCL information being based at least in part on which one of the first and second subset of CORESETs that the CORESET the DCI is transmitted on belongs to.

Example B2. The method of Example B1, wherein the DCI comprises a transmission configuration indicator (TCI) field comprising a value indicating at least one TCI state, the QCL information being determined from and/or based at least in part on the indicated at least one TCI state.

Example B3. The method of any one of Examples B1 and B2, wherein the signaling is transmitted/received based at least in part on a spatial domain filter, the spatial domain filter being based at least in part on which one of the first and second subset of CORESETs that the CORESET the DCI is transmitted on belongs to; and/or
wherein the signaling is a beam transmitted/received based at least in part on the spatial domain filter associated with the one the first and second subset of CORESETs that the CORESET the DCI is transmitted on belongs to; and/or
wherein the spatial domain filter comprises at least one of a spatial domain transmit filter and a spatial domain receive filter.

Example B4. The method of any one of Examples B1-B3, wherein the signaling transmitted to the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI; and/or
wherein the signaling received from the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

Example B5. The method of any one of Examples B1-B4, wherein the transmitted signaling comprises at least one of a physical downlink shared channel (PDSCH), a reference signal (RS) and a CSI-RS; and/or
wherein the received signaling comprises at least one of an acknowledgement/non-acknowledgement (ACK/NACK), a sounding reference signal (SRS) and a physical uplink shared channel (PUSCH).

Example B6. The method of any one of Examples B2-B5, wherein which one or more of the at least one first and second reference signals and/or the at least one first and second channels that the indicated at least one TCI state applies to/is updated by is based at least in part on a type of the at least one TCI state.

Example B7. The method of Example B6, wherein the type of the at least one TCI state comprises at least one of a joint TCI state, a downlink (DL) TCI state and an uplink (UL) TCI state.

Example B8. The method of any one of Examples B3-B7, wherein if the type of an indicated TCI state comprises the joint TCI state, the indicated TCI state applies to/updates both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example B9. The method of any one of Examples B3-B7, if the type of an indicated TCI state is the DL TCI state, the indicated TCI state applies to/updates the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example B10. The method of any one of Examples B3-B7, if the type of an indicated TCI state is the UL TCI state, the indicated TCI state applies to/updates the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is transmitted on belongs to.

Example B11. The method of any one of Examples B2-B10, wherein spatial domain filters are updated only if the indicated TCI state is different from an active TCI state that is associated with the one of the first and second subset of CORESETs that the CORESET the DCI is transmitted on belongs to.

Example B12. The method of any one of Examples B2-B11, wherein the value comprised in the TCI field in the DCI is a TCI field codepoint out of a plurality of TCI field codepoints, the TCI field codepoint indicating the at least one TCI state out of a plurality of TCI states configured to the wireless device 22; and/or
wherein the value comprised in the DCI is one of a joint UL/DL TCI state beam indication, a downlink (DL) TCI state beam indication and an uplink (UL) TCI state beam indication.

Example B13. The method of Example B12, wherein one of the plurality of TCI field codepoints configured to the wireless device 22 indicates that there is no TCI state update.

Example B14. The method of any one of Examples B2-B13, wherein the at least one TCI state that is indicated by the TCI field codepoint is based at least in part on a DCI format of the DCI transmitted on the PDCCH.

Example B15. The method of any one of Examples B2-B14, wherein if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

Example B16. The method of any one of Examples B1-B15, further comprising:
transmitting configuration information to the wireless device 22, the configuration information configuring the wireless device 22 with a plurality of CORESETs, the first subset of CORESETs being associated with a first CORESET pool index value and the second subset of CORESETs being associated with a second CORESET pool index value.

Example B17. The method of Example B16, wherein the first and second subsets are disjoint sets.

Example B18. The method of any one of Examples B1-B17, wherein, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index.

Example B19. The method of any one of Examples B1-B18, wherein the association of the at least one first reference signal and/or the at one first channel to the first subset of CORESETs and the association of the at least one second reference signal and/or the at one second channel to the second subset of CORESETs is via a radio resource control (RRC) configuration.

Example B20. The method of Example B19, wherein the RRC configuration comprises a channel/signal resource configuration comprising an index value identifying the one of the first and second subsets of CORESETs to be associated with the channel/signal resource.

Example B21. The method of any one of Examples B1-B20, wherein the association of the at least one first reference signal and/or the at one first channel to the first subset of CORESETs and the association of the at least one second reference signal and/or the at one second channel to the second subset of CORESETs is via a medium access control (MAC) control element (CE).

Example B22. The method of Example B21, wherein the MAC CE indicates a channel/signal resource associated with one of the first and second subsets of CORESETs to be associated with the channel/signal resource; and/or
wherein the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources.

Example B23. The method of Example B19, wherein the RRC configuration information comprises a plurality of CORESET pool index values, each index value identifying a corresponding subset of CORESETs and indicating at least one reference signal/channel associated with the respective index value.

Example B24. The method of any one of Examples B1-B23, further comprising:
activating TCI states in a MAC CE, the activated TCI states being mapped to TCI field codepoints; and
wherein the activated TCI states comprising one of a joint TCI state, a DL TCI state and an UL TCI state.

Example B25. The method of Example B24, wherein the one of the joint TCI state, the DL TCI state and the UL TCI state is activated per corresponding CORESET subset and/or per corresponding CORESET pool index value.

Example B26. The method of any one of Examples B1-B25, further comprising receiving at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one received ACK/NACK.

Example B27. The method of Example B26, further comprising receiving separate acknowledgements/non-acknowledgements (ACK/NACKs) for physical downlink shared channels (PDSCHs) scheduled by the DCI and/or another DCI.

Example B28. The method of Example B26, further comprising receiving joint acknowledgements/non-acknowledgements (ACK/NACKs) for physical downlink shared channels (PDSCHs) scheduled by the DCI and/or another DCI.

Example B29. The method of any one of Examples B1-B28, wherein the QCL information and/or spatial domain filters associated with the corresponding subset of CORESETs are independently updated at the wireless device 22 at different times.

Example B30. The method of Example B26-B29, wherein the time of the update is associated with the corresponding subset of CORESETs and/or the corresponding index value identifying the subset.

Example B31. The method of any one of Examples B1-B28, wherein the QCL information and/or spatial domain filters associated with the corresponding subset of CORESETs are jointly updated at the wireless device 22 at a same time.

Example B32. The method of any one of Examples B1-B31,
wherein the at least one first and second reference signals and/or the at least one first and second channels associated with the first and second subsets of CORESETs configured to the wireless device 22 are also associated with different cell identifiers (IDs);
wherein the different cell IDs are associated with multiple transmit receive points (TRPs), the multiple TRPs being associated with one or more network nodes 16 in communication with the wireless device 22;
wherein the QCL information is indicated via a transmission configuration indicator (TCI) state; and/or
wherein the QCL information comprises at least one of a delay spread parameter, a Doppler parameter, an average delay parameter, a Doppler shift parameter, a spatial domain receive parameter and a spatial domain transmit parameter.

Example C1. A wireless device 22 configured to communicate with a network node 16, the wireless device 22 configured to, and/or comprising a radio interface and/or processing circuitry configured to:
receive information associating at least one first reference signal and/or at one first channel to at least a first subset of control resource sets (CORESETs);
receive information associating at least one second reference signal and/or at least one second channel to at least a second subset of CORESETs;
receive a downlink control information (DCI) on a physical downlink control channel (PDCCH) in a CORESET to the wireless device 22; and
transmit and/or receive signaling, the signaling being transmitted/received based at least in part on quasi-colocation (QCL) information, the QCL information being based at least in part on which one of the first and second subset of CORESETs that the CORESET the DCI is received on belongs to.

Example C2. The wireless device 22 of Example C1, wherein the DCI comprises a transmission configuration indicator (TCI) field comprising a value indicating at least one TCI state, the QCL information being determined from and/or based at least in part on the indicated at least one TCI state.

Example C3. The wireless device 22 of any one of Examples C1 and C2, wherein the signaling is transmitted/received based at least in part on a spatial domain filter, the spatial domain filter being based at least in part on which one of the first and second subset of CORESETs that the CORESET the DCI is received on belongs to; and/or
wherein the signaling is a beam transmitted/received based at least in part on the spatial domain filter associated with the one the first and second subset of CORESETs that the CORESET the DCI is received on belongs to; and/or
wherein the spatial domain filter comprises at least one of a spatial domain transmit filter and a spatial domain receive filter.

Example C4. The wireless device 22 of any one of Examples C1-C3, wherein the signaling received by the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI; and/or
wherein the signaling transmitted by the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

Example C5. The wireless device 22 of any one of Examples C1-C4, wherein the received signaling comprises at least one of a physical downlink shared channel (PDSCH), a reference signal (RS) and a CSI-RS that is related to and/or triggered by the received DCI; and/or
wherein the transmitted signaling comprises at least one of an acknowledgement/non-acknowledgement (ACK/NACK), a sounding reference signal (SRS) and a physical uplink shared channel (PUSCH) that is related to and/or triggered by the received DCI.

Example C6. The wireless device 22 of any one of Examples C2-C5, wherein which one or more of the at least one first and second reference signals and/or the at least one first and second channels that the indicated at least one TCI state applies to/is updated by is based at least in part on a type of the at least one TCI state.

Example C7. The wireless device 22 of Example C6, wherein the type of the at least one TCI state comprises at least one of a joint TCI state, a downlink (DL) TCI state and an uplink (UL) TCI state.

Example C8. The wireless device 22 of any one of Examples C3-C7, wherein if the type of an indicated TCI state comprises the joint TCI state, the indicated TCI state applies to/updates both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example C9. The wireless device 22 of any one of Examples C3-C7, if the type of an indicated TCI state is the DL TCI state, the indicated TCI state applies to/updates the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example C10. The wireless device 22 of any one of Examples C3-C7, if the type of an indicated TCI state is the UL TCI state, the indicated TCI state applies to/updates the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example C11. The wireless device 22 of any one of Examples C2-C10, wherein spatial domain filters are updated by the wireless device 22 only if the indicated TCI state is different from an active TCI state that is associated with the one of the first and second subset of CORESETs that the CORESET the DCI is received on belongs to.

Example C12. The wireless device 22 of any one of Examples C2-C11, wherein the value comprised in the TCI field in the DCI is a TCI field codepoint out of a plurality of TCI field codepoints, the TCI field codepoint indicating the at least one TCI state out of a plurality of TCI states configured to the wireless device 22; and/or
wherein the value comprised in the DCI is one of a joint UL/DL TCI state beam indication, a downlink (DL) TCI state beam indication and an uplink (UL) TCI state beam indication.

Example C13. The wireless device 22 of Example C12, wherein one of the plurality of TCI field codepoints configured to the wireless device 22 indicates that there is no TCI state update.

Example C14. The wireless device 22 of any one of Examples C2-C13, wherein the at least one TCI state that is indicated by the TCI field codepoint is based at least in part on a DCI format of the DCI received on the PDCCH.

Example C15. The wireless device 22 of any one of Examples C2-C14, wherein if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

Example C16. The wireless device 22 of any one of Examples C1-C15, wherein the wireless device 22 and/or the radio interface and/or the processing circuitry is configured to cause the wireless device 22 to: receive configuration information, the configuration information configuring the wireless device 22 with a plurality of CORESETs, the first subset of CORESETs being associated with a first CORESET pool index value and the second subset of CORESETs being associated with a second CORESET pool index value.

Example C17. The wireless device 22 of Example C16, wherein the first and second subsets are disjoint sets.

Example C18. The wireless device 22 of any one of Examples C1-C17, wherein, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index.

Example C19. The wireless device 22 of any one of Examples C1-C18, wherein the association of the at least one first reference signal and/or the at one first channel to the first subset of CORESETs and the association of the at least one second reference signal and/or the at one second channel to the second subset of CORESETs is via a radio resource control (RRC) configuration.

Example C20. The wireless device 22 of Example C19, wherein the RRC configuration comprises a channel/signal resource configuration comprising an index value identifying the one of the first and second subsets of CORESETs to be associated with the channel/signal resource.

Example C21. The wireless device 22 of any one of Examples C1-C20, wherein the association of the at least one first reference signal and/or the at one first channel to the first subset of CORESETs and the association of the at least one second reference signal and/or the at one second channel to the second subset of CORESETs is via a medium access control (MAC) control element (CE).

Example C22. The wireless device 22 of Example C21, wherein the MAC CE indicates a channel/signal resource associated with one of the first and second subsets of CORESETs to be associated with the channel/signal resource; and/or wherein the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources.

Example C23. The wireless device 22 of Example C19, wherein the RRC configuration information comprises a plurality of CORESET pool index values, each index value identifying a corresponding subset of CORESETs and indicating at least one reference signal/channel associated with the respective index value.

Example C24. The wireless device 22 of any one of Examples C1-C23, wherein the wireless device 22 and/or the radio interface and/or the processing circuitry is configured to cause the wireless device 22 to: receive an activation of TCI states in a MAC CE, the activated TCI states being mapped to TCI field codepoints; and wherein the activated TCI states comprising one of a joint TCI state, a DL TCI state and an UL TCI state.

Example C25. The wireless device 22 of Example C24, wherein the one of the joint TCI state, the DL TCI state and the UL TCI state is activated per corresponding CORESET subset and/or per corresponding CORESET pool index value.

Example C26. The wireless device 22 of any one of Examples C1-C25, wherein the wireless device 22 and/or the radio interface and/or the processing circuitry is configured to cause the wireless device 22 to: transmit at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one transmitted ACK/NACK.

Example C27. The wireless device 22 of Example C26, wherein the wireless device 22 and/or the radio interface and/or the processing circuitry is configured to cause the wireless device 22 to:
transmit separate acknowledgements/non-acknowledgements (ACK/NACKs) for physical downlink shared channels (PDSCHs) scheduled by the DCI and/or another DCI.

Example C28. The wireless device 22 of Example C26, wherein the wireless device 22 and/or the radio interface and/or the processing circuitry is configured to cause the wireless device 22 to:
transmit joint acknowledgements/non-acknowledgements (ACK/NACKs) for physical downlink shared channels (PDSCHs) scheduled by the DCI and/or another DCI.

Example C29. The wireless device 22 of any one of Examples C1-C28, wherein the QCL information and/or spatial domain filters associated with the corresponding subset of CORESETs are independently updated at the wireless device 22 at different times.

Example C30. The wireless device 22 of Example C26-C29, wherein the time of the update is associated with the corresponding subset of CORESETs and/or the corresponding index value identifying the subset.

Example C31. The wireless device 22 of any one of Examples C1-C28, wherein the QCL information and/or spatial domain filters associated with the corresponding subset of CORESETs are jointly updated at the wireless device 22 at a same time.

Example C32. The wireless device 22 of any one of Examples C1-C31,
wherein the at least one first and second reference signals and/or the at least one first and second channels associated with the first and second subsets of CORESETs configured to the wireless device 22 are also associated with different cell identifiers (IDs);
wherein the different cell IDs are associated with multiple transmit receive points (TRPs), the multiple TRPs being associated with one or more network nodes 16 in communication with the wireless device 22;
wherein the QCL information is indicated via a transmission configuration indicator (TCI) state; and/or
wherein the QCL information comprises at least one of a delay spread parameter, a Doppler parameter, an average delay parameter, a Doppler shift parameter, a spatial domain receive parameter and a spatial domain transmit parameter.

Example D1. A method implemented in a wireless device 22, the method comprising:
receiving information associating at least one first reference signal and/or at one first channel to at least a first subset of control resource sets (CORESETs);
receiving information associating at least one second reference signal and/or at least one second channel to at least a second subset of CORESETs;
receiving a downlink control information (DCI) on a physical downlink control channel (PDCCH) in a CORESET to the wireless device 22; and
transmitting and/or receiving signaling, the signaling being transmitted/received based at least in part on quasi-colocation (QCL) information, the QCL information being based at least in part on which one of the first and second subset of CORESETs that the CORESET the DCI is received on belongs to.

Example D2. The method of Example D1, wherein the DCI comprises a transmission configuration indicator (TCI) field comprising a value indicating at least one TCI state, the QCL information being determined from and/or based at least in part on the indicated at least one TCI state.

Example D3. The method of any one of Examples D1 and D2, wherein the signaling is transmitted/received based at least in part on a spatial domain filter, the spatial domain filter being based at least in part on which one of the first and second subset of CORESETs that the CORESET the DCI is received on belongs to; and/or
wherein the signaling is a beam transmitted/received based at least in part on the spatial domain filter associated with the one the first and second subset of CORESETs that the CORESET the DCI is received on belongs to; and/or
wherein the spatial domain filter comprises at least one of a spatial domain transmit filter and a spatial domain receive filter.

Example D4. The method of any one of Examples D1-D3, wherein the signaling received by the wireless device 22 comprises (i) a signal/channel scheduled, granted, allocated and/or triggered by the DCI, or (ii) is comprised in a downlink (DL) channel related to the signal/channel scheduled, granted, allocated and/or triggered by the DCI; and/or
wherein the signaling transmitted by the wireless device 22 is (i) a signal/channel scheduled, granted, allocated and/or triggered by the DCI, or (ii) is comprised in an uplink (UL) channel related to the signal/channel scheduled, granted, allocated and/or triggered by the DCI.

Example D5. The method of any one of Examples D1-D4, wherein the received signaling comprises at least one of a physical downlink shared channel (PDSCH), a reference signal (RS) and a CSI-RS that is related to and/or triggered by the received DCI; and/or
wherein the transmitted signaling comprises at least one of an acknowledgement/non-acknowledgement (ACK/NACK), a sounding reference signal (SRS) and a physical uplink shared channel (PUSCH) that is related to and/or triggered by the received DCI.

Example D6. The method of any one of Examples D2-D5, wherein which one or more of the at least one first and second reference signals and/or the at least one first and second channels that the indicated at least one TCI state applies to/is updated by is based at least in part on a type of the at least one TCI state.

Example D7. The method of Example D6, wherein the type of the at least one TCI state comprises at least one of a joint TCI state, a downlink (DL) TCI state and an uplink (UL) TCI state.

Example D8. The method of any one of Examples D3-D7, wherein if the type of an indicated TCI state comprises the joint TCI state, the indicated TCI state applies to/updates both the spatial domain transmit and receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example D9. The method of any one of Examples D3-D7, if the type of an indicated TCI state is the DL TCI state, the indicated TCI state applies to/updates the spatial domain receive filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example D10. The method of any one of Examples D3-D7, if the type of an indicated TCI state is the UL TCI state, the indicated TCI state applies to/updates the spatial domain transmit filters corresponding to the one of (i) the at least one first reference signal and/or at one first channel and (ii) the at least one second reference signal and/or at least one second channel that is associated with the one of the first and second subset of CORESETs that the CORESET the DCI is received on belongs to.

Example D11. The method of any one of Examples D2-D10, wherein spatial domain filters are updated by the wireless device 22 only if the indicated TCI state is different from an active TCI state that is associated with the one of the first and second subset of CORESETs that the CORESET the DCI is received on belongs to.

Example D12. The method of any one of Examples D2-D11, wherein the value comprised in the TCI field in the DCI is a TCI field codepoint out of a plurality of TCI field codepoints, the TCI field codepoint indicating the at least one TCI state out of a plurality of TCI states configured to the wireless device 22; and/or
wherein the value comprised in the DCI is one of a joint UL/DL TCI state beam indication, a downlink (DL) TCI state beam indication and an uplink (UL) TCI state beam indication.

Example D13. The method of Example D12, wherein one of the plurality of TCI field codepoints configured to the wireless device 22 indicates that there is no TCI state update.

Example D14. The method of any one of Examples D2-D13, wherein the at least one TCI state that is indicated by the TCI field codepoint is based at least in part on a DCI format of the DCI received on the PDCCH.

Example D15. The method of any one of Examples D2-D14, wherein if the value comprised in the DCI indicates the UL TCI state and/or the DL TCI state, the spatial domain receive filters associated with the one of the first and second subset of CORESETs that the CORESET belongs to are updated at the wireless device 22 according to the indicated DL TCI state and/or the special domain transmit filters associated with the one of the first and second subset of CORESETs that the CORESET belongs to are updated at the wireless device 22 according to the indicated UL TCI state.

Example D16. The method of any one of Examples D1-D15, further comprising receiving configuration information, the configuration information configuring the method with a plurality of CORESETs, the first subset of CORESETs being associated with a first CORESET pool index value and the second subset of CORESETs being associated with a second CORESET pool index value.

Example D17. The method of Example D16, wherein the first and second subsets are disjoint sets.

Example D18. The method of any one of Examples D1-D17, wherein, based at least in part on the association of the at least one first reference signal and/or the at one first channel to the first subset of CORESETs and the association of the at least one second reference signal and/or the at one second channel to the second subset of CORESETs, spatial domain transmit and/or receive filters are maintained at the wireless device 22 per corresponding CORESET subset and/or per corresponding CORESET pool index.

Example D19. The method of any one of Examples D1-D18, wherein the association of the at least one first reference signal and/or the at one first channel to the first subset of CORESETs and the association of the at least one second reference signal and/or the at one second channel to the second subset of CORESETs is via a radio resource control (RRC) configuration.

Example D20. The method of Example D19, wherein the RRC configuration comprises a channel/signal resource configuration comprising an index value identifying the one of the first and second subsets of CORESETs to be associated with the channel/signal resource.

Example D21. The method of any one of Examples D1-D20, wherein the association of the at least one first reference signal and/or the at one first channel to the first subset of CORESETs and the association of the at least one second reference signal and/or the at one second channel to the second subset of CORESETs is via a medium access control (MAC) control element (CE).

Example D22. The method of Example D21, wherein the MAC CE indicates a channel/signal resource associated with one of the first and second subsets of CORESETs to be associated with the channel/signal resource; and/or wherein the channel/signal resource comprises at least one of: a PUCCH resource, a group of PUCCH resources, a SRS resource, a group of SRS resources, a CSI-RS resource, a group of CSI-RS resources, a reference signal (RS) resource, a group of RS resources.

Example D23. The method of Example D19, wherein the RRC configuration information comprises a plurality of CORESET pool index values, each index value identifying a corresponding subset of CORESETs and indicating at least one reference signal/channel associated with the respective index value.

Example D24. The method of any one of Examples D1-D23, further comprising receiving an activation of TCI states in a MAC CE, the activated TCI states being mapped to TCI field codepoints; and wherein the activated TCI states comprising one of a joint TCI state, a DL TCI state and an UL TCI state.

Example D25. The method of Example D24, wherein the one of the joint TCI state, the DL TCI state and the UL TCI state is activated per corresponding CORESET subset and/or per corresponding CORESET pool index value.

Example D26. The method of any one of Examples D1-D25, further comprising transmitting at least one acknowledgement/non-acknowledgement (ACK/NACK) for at least one physical downlink shared channel (PDSCH) scheduled by the DCI, a time at which the wireless device 22 updates the QCL information and/or the indicated at least one TCI state is based at least in part on the at least one transmitted ACK/NACK.

Example D27. The method of Example D26, further comprising transmitting separate acknowledgements/non-acknowledgements (ACK/NACKs) for physical downlink shared channels (PDSCHs) scheduled by the DCI and/or another DCI.

Example D28. The method of Example D26, further comprising transmitting joint acknowledgements/non-acknowledgements (ACK/NACKs) for physical downlink shared channels (PDSCHs) scheduled by the DCI and/or another DCI.

Example D29. The method of any one of Examples D1-D28, wherein the QCL information and/or spatial domain filters associated with the corresponding subset of CORESETs are independently updated at the wireless device 22 at different times.

Example D30. The method of Example D26-D29, wherein the time of the update is associated with the corresponding subset of CORESETs and/or the corresponding index value identifying the subset.

Example D31. The method of any one of Examples D1-D28, wherein the QCL information and/or spatial domain filters associated with the corresponding subset of CORESETs are jointly updated at the wireless device 22 at a same time.

Example D32. The method of any one of Examples D1-D29,
wherein the at least one first and second reference signals and/or the at least one first and second channels associated with the first and second subsets of CORESETs configured to the wireless device 22 are also associated with different cell identifiers (IDs);
wherein the different cell IDs are associated with multiple transmit receive points (TRPs), the multiple TRPs being associated with one or more network nodes 16 in communication with the wireless device 22;
wherein the QCL information is indicated via a transmission configuration indicator (TCI) state; and/or
wherein the QCL information comprises at least one of a delay spread parameter, a Doppler parameter, an average delay parameter, a Doppler shift parameter, a spatial domain receive parameter and a spatial domain transmit parameter.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-17. (canceled)

18. A method implemented by a network node configured to communicate with a wireless device, the method comprising:
determining at least one downlink resource for transmission to the wireless device, the at least one downlink resource belonging to a first control resource set, CORESET, of a plurality of CORESETs, the first CORESET being associated with a respective CORESET pool index;
causing transmission of at least one first downlink signal to the wireless device on the determined at least one downlink resource; and
at least one of:
causing transmission of at least one second downlink signal to the wireless device, the at least one second downlink signal being received by the wireless device based on a quasi-colocation, QCL, parameter, the QCL parameter being associated with the CORESET pool index; and
receiving at least one uplink signal transmitted by the wireless device, the at least one uplink signal being transmitted by the wireless device based on a first spatial domain filter, the first spatial domain filter being associated with the CORESET pool index.

19. (canceled)

20. (canceled)

21. The method of claim 18, wherein the at least one first downlink signal includes a downlink control information, DCI, message, the DCI message including a transmission configuration indicator, TCI, field that includes a TCI value indicating at least one indicated TCI state.

22. The method of claim 21, wherein the QCL parameter is further based on the at least one indicated TCI state.

23. The method of claim 21, wherein the first spatial domain filter is further based on the at least one indicated TCI state.

24. (canceled)

25. The method of claim 18, wherein the TCI value includes at least one TCI field codepoint, the at least one TCI field codepoint being associated with the at least one indicated TCI state, and wherein the at least one TCI field codepoint is mapped to the at least one indicated TCI state based on a format of the at least one first downlink signal.

26. (canceled)

27. (canceled)

28. (canceled)

29. The method of claim 18, wherein the at least one second downlink signal is received by the wireless device based on a downlink beam, the downlink beam being determined based on a second spatial domain filter, the second spatial domain filter being associated with the CORESET pool index, and wherein the method further comprises updating both the first and second spatial domain filters based on the at least one indicated TCI state indicating a joint TCI state.

30. The method of claim 18, wherein the at least one second downlink signal is received by the wireless device based on a downlink beam, the downlink beam being determined based on a second spatial domain filter, the second spatial domain filter being associated with the CORESET pool index, and wherein the method further comprises updating the second spatial domain filter based on the at least one indicated TCI state indicating a downlink TCI state.

31. The method of claim 21, wherein the method further comprises updating the first spatial domain filter based on the at least one indicated TCI state indicating an uplink TCI state.

32. (canceled)

33. (canceled)

34. The method of claim 18, wherein each of the plurality of CORESETs is associated with a respective CORESET pool of a plurality of CORESET pools, each of the plurality of CORESET pools being associated with a respective transmission and reception point, TRP.

35.-51. (canceled)

52. A method implemented by a wireless device configured to communicate with a network node, the method comprising:
receiving at least one first downlink signal from the network node on at least one downlink resource, the at least one downlink resource belonging to a first control resource set, CORESET, of a plurality of CORESETs;
determining a respective CORESET pool index based on the first CORESET; and
at least one of:
receiving at least one second downlink signal from the network node, the at least one second downlink signal being received by the wireless device based on a quasi-colocation, QCL, parameter, the QCL parameter being associated with the respective CORESET pool index; and
causing transmission of at least one uplink signal to the network node, the at least one uplink signal being transmitted based on a first spatial domain filter, the first spatial domain filter being associated with the respective CORESET pool index.

53. The method of claim 52, wherein the at least one second downlink signal is a physical downlink shared channel, PDSCH.

54. (canceled)

55. The method of claim 52, wherein the at least one first downlink signal includes a downlink control information (DCI) message, the DCI message including a transmission configuration indicator (TCI) field that includes a TCI value indicating at least one indicated TCI state.

56. The method of claim 55, wherein the QCL parameter is further based on the at least one indicated TCI state.

57. The method of claim 55, wherein the first spatial domain filter is further based on the at least one indicated TCI state.

58. The method of claim 55, wherein the TCI value includes at least one TCI field codepoint, the at least one TCI field codepoint being associated with the at least one indicated TCI state.

59. The method of claim 58, wherein the at least one TCI field codepoint is mapped to the at least one indicated TCI state based on a format of the first downlink signal.

60. (canceled)

61. The method of claim 55, wherein the receiving of the at least one second downlink signal from the network node is based on a downlink beam, the downlink beam being determined based on a second spatial domain filter, the second spatial domain filter being associated with the respective CORESET pool index.

62. (canceled)

63. The method of claim 61, wherein the method further includes updating both the first and second spatial domain filters based on the at least one indicated TCI state indicating a joint TCI state.

64. The method of claim 61, wherein the method further comprises updating the second spatial domain filter based on the at least one indicated TCI state indicating a downlink TCI state.

65. The method of claim 55, wherein the method further comprises updating the first spatial domain filter based on the at least one indicated TCI state indicating an uplink TCI state.

66. (canceled)

67. (canceled)

68. The method of claim 52, wherein each of the plurality of CORESETs is associated with a respective CORESET pool of a plurality of CORESET pools, each of the plurality of CORESET pools being associated with a respective transmission and reception point, TRP.
